(19) United States
(12) Patent Application Publication
(10) Pub. No.: US 2007/0280269 A1
(43) Pub. Date: Dec. 6, 2007

(54) AUTOMATED CHANCE-BASED PROMOTIONAL AWARD SERVICE FOR PHYSICAL ESTABLISHMENTS

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, LLC, Pismo Beach, CA (US)

(21) Appl. No.: 11/841,868

(22) Filed: Aug. 20, 2007

Related U.S. Application Data
(63) Continuation-in-part of application No. 11/772,803, filed on Jul. 2, 2007.
(63) Continuation-in-part of application No. 11/383,197, filed on May 12, 2006.
(63) Continuation-in-part of application No. 11/425,990, filed on Jun. 22, 2006.
(63) Continuation-in-part of application No. 11/422,065, filed on Jun. 2, 2006.
(63) Continuation-in-part of application No. 11/551,702, filed on Oct. 20, 2006.
(60) Provisional application No. 60/930,278, filed on May 15, 2007.
(60) Provisional application No. 60/906,606, filed on Mar. 12, 2007.
(60) Provisional application No. 60/925,489, filed on Apr. 20, 2007.
(60) Provisional application No. 60/918,772, filed on Mar. 17, 2007.
(60) Provisional application No. 60/928,729, filed on May 10, 2007.
(60) Provisional application No. 60/723,021, filed on Oct. 1, 2005.
(60) Provisional application No. 60/731,180, filed on Oct. 29, 2005.
(60) Provisional application No. 60/691,692, filed on Jun. 16, 2005.
(60) Provisional application No. 60/748,832, filed on Dec. 10, 2005.

(51) Int. Cl. H04L 12/56

(52) U.S. Cl. 370/399

(57) ABSTRACT

An establishment-based server is configured to receive electronic attendance messages from each of a plurality of portable computing devices wherein each electronic attendance message indicates that a user associated with the portable computing device is in attendance within an identified physical establishment. In response to the receipt of an electronic attendance message, the server automatically performs a process of chance to determine if a user associated with the portable computing device wins a free or discounted product or service of the identified physical establishment. If so, the server automatically sends an award message to the portable computing device, informing that a free or discounted product or service has been won. The award message may be redeemed by the user within the identified establishment for the free or discounted product or service. The award message may be time-limited such that it may only be redeemed within a limited time period.

### RELATED APPLICATION DATA

This application claims priority to provisional application Ser. Nos. (a) 60/930,278, filed May 15, 2007, (b) 60/906,606, filed Mar. 12, 2007, and (c) 60/925,489, filed Apr. 20, 2007, the disclosures of which is hereby incorporated by reference herein in their entirety; this application claims priority from provisional application Ser. No. 60/918,772, filed Mar. 17, 2007, the disclosure of which is hereby incorporated by reference herein in its entirety; this application is a continuation-in-part of U.S. patent application Ser. No. 11/772,803, filed Jul. 2, 2007 by the present inventor, which claims priority to provisional application Ser. No. 60/928,729, filed May 10, 2007, the disclosures of which is hereby incorporated by reference herein in their entirety; this application is a continuation-in-part of four co-pending applications by the present inventor, including U.S. patent application Serial Nos. (a) Ser. No. 11/383,197, which claims priority to Provisional Patent Application Ser. No. 60/723,021, filed Oct. 1, 2005, (b) Ser. No. 11/425,990, which claims priority to provisional application Ser. No. 60/731,180, filed Oct. 29, 2005, (c) Ser. No. 11/422,065, which claims priority to Provisional Patent Application Ser. No. 60/691,692, filed Jun. 16, 2005, and (d) Ser. No. 11/551,702, which claims priority to Provisional Patent Application Ser. No. 60/748,832, filed Dec. 10, 2005, the disclosure of which are incorporated herein by reference in their entirety.

### FIELD OF THE APPLICATION

The present invention relates generally to a messaging method and system for awarding promotional offers to portable computing devices within designated physical establishments.

### BACKGROUND

As disclosed by the present inventor in co-pending U.S. patent application Ser. No. 11/383,197, filed May 12, 2006, which claims priority to Provisional Patent Application Ser. No. 60/723,021, filed Oct. 1, 2005, methods, systems, and apparatus are disclosed for enabling a centralized establishment-based patron tracking and messaging server that monitors the attendance of particular users, each indexed by a unique User ID, within each of a plurality of localized physical establishments, each indexed by unique Establishment ID. More specifically, the aforementioned patent application discloses a plurality of embodiments in which a centralized establishment-based patron tracking and messaging server “receives a unique ID for each user who is currently patronizing each of a plurality of establishments along with a unique ID that identifies which establishment each user is patronizing.” In some embodiments, the server also maintains data about each user “that reflect their visiting behavior with respect to particular location-based establishments. Visiting behavior data includes, for example, an indication of which location-based establishments have been visited by the particular user and the frequency and/or number of times the user has visited each location based establishment.” In some such embodiments, an Establishment User List is maintained by the central server for each of a plurality of establishments, each Establishment User List including a unique ID for each of the users “who are currently determined to be patronizing the particular establishment.”

In certain embodiments disclosed in the aforementioned patent, each user is associated with a unique User ID that is communicated from a portable computing device of that user, for example that user's mobile phone, to the central server when that user enters and/or is located within a particular establishment. In addition, each establishment is assigned a unique identifier referred to as an Establishment ID that is also communicated to the server “to identify which establishment a particular user is patronizing.” In addition, certain embodiments of the aforementioned patent enabled establishment-specific information about each indexed establishment to be stored in an Establishment Database accessible to the central server, the establishment-specific information including “descriptive information, service information, current demographic profile information” relating to the indexed establishment. In addition, certain embodiments of the aforementioned patent enable establishment-specific messages to be conveyed back a particular user, relating to the particular establishment he or she is patronizing, in response to the receipt of a unique Establishment ID from a portable computing device of that particular user. In some such embodiments, the establishment-specific messages conveyed back to users include information accessed from the Establishment Database. In some embodiments, the server “also maintains and/or has access to a Personal Profile Database which contains personal demographic characteristics about each user indexed by unique ID.” In some such embodiments, the establishment-specific messages conveyed back to users include information accessed from the Personal Profile Database, relating to one or more users present within the particular establishment.

Thus, the aforementioned prior applications (Ser. Nos. 11/383,197 and 60/723,021) disclose a plurality of methods, systems and apparatus that are operative to enable a novel establishment-based tracking and messaging service that is moderated by a centralized patron tracking server, the tracking server operative to monitor of the attendance of particular users, each indexed by a unique User ID, within a plurality of particular localized physical establishments, each indexed by unique Establishment ID. The server also enables the passing of establishment-specific messages to and from patrons of those establishments based at least in part upon their presumed attendance within a particular establishment. The methods, apparatus, and computer program products disclosed herein thus follow a “tell us you're here” patron tracking methodology in which electronic messages are sent to the centralized patron tracking server indicating the attendance of a particular individual user (indexed by unique User ID) within a particular physical establishment (indexed by unique Establishment ID). Such messages, referred to herein as “attendance messages” comprise an electronic message that is sent to the centralized patron tracking server that contains a unique Establishment ID of a unique localized physical establishment and an indication as to which user is being identified as being currently present within the establishment. Based up the receipt of a plurality of such attendance messages, the central server stores an in memory an indication of the presumed attendance of each of a plurality of particular users within each of a plurality of particular establishments. Such a data store of presumed customer attendance within each of a plurality of localized physical establishments is referred to herein as an establishment attendance database. An establishment attendance database may be comprised of an Establishment User List for each of a plurality of establishments, thereby documenting which of a plurality of active users are present within each of a plurality of participating establishments.

The aforementioned prior applications (Ser. Nos. 11/383,197 and 60/723,021) also disclose a methods, systems and apparatus that enable a user to send an “attendance message” indicating his or her attendance within a particular localized physical establishment by interacting manually with a mobile computing device on his or her person. More specifically, a user may employ a messaging function of a mobile computing device on his or her person in which “the user sends an encoded message such as a text message indicating that the user has either entered or exited a particular location-based establishment.” The message typically includes “a representation of the location-based establishment's unique establishment ID.” Thus, a particular user may, for example, send a text message to the central server, the text message including a unique establishment ID for an establishment that he or she has just entered, as a way of conveying an attendance message with respect to that particular establishment. The central server receives the message, parses the establishment ID from the message, and in response adds the particular user to the Establishment User List for the particular establishment (i.e., updates the establishment attendance database to reflect the fact that the particular user is believed to be present within the particular establishment). In some embodiments of the aforementioned patent applications, the text message sent from the portable computing device of the particular user may also include a flag or other indicator indicating if the user has “entered, exited, or is currently at or within the referenced establishment.” In this way a user may inform the central server as to his or her arrival, departure, or presence within a particular localized physical establishment by sending an electronic message, for example, an SMS text message to the centralized establishment server, the message referencing the unique establishment ID of the particular establishment.

In some embodiments of the aforementioned patent applications, the text message sent from the portable computing device of the particular user may also include the unique user ID of the user encoded within the message. In other embodiments the unique user ID of the user is accessed and/or referenced in relation to the unique electronic address of the portable computing device of the user. In some embodiments an attendance message is automatically sent from the portable computing device of a user to the establishment-based patron tracking server in response to a triggered RFID tag. In other embodiments the attendance message an attendance message is automatically sent and/or received in response to other sensor readings and/or other detected signals.

As disclosed by the present inventor in co-pending patent application Ser. No. 11/422,065, filed Jun. 2, 2006, which claims priority to Provisional Patent Application Ser. No. 60/691,692, filed Jun. 16, 2005, the disclosures of which are incorporated herein by reference, additional methods, systems, and apparatus are disclosed for enabling a server process to monitor of the attendance of each of a plurality of particular users within a restaurant-type establishment based upon electronic messages received from portable computing devices on their person. As disclosed in the aforementioned patents, the patron tracking server is configured to monitor the attendance of particular users within a particular establishment, each indexed by a unique ID associated with their portable computing device of that user. In addition, the user may send a message from his or her portable computing device to the server process, the message indicating a unique seating location of the user within the establishment, referenced through a unique seating location ID. In this way a server process may keep track not only of whether a user is present within an establishment, but also where within the establishment the user is seated. In some such embodiments, the seating location of the user is conveyed from a portable computing device of the user, such as the user's PDA or mobile phone, as a result of the user entering seating identification data entered into his or her portable computing device and conveying the seating identification data as an electronic message to the server process. In addition the aforementioned patent discloses methods by which patrons of an establishment may receive establishment-specific information and/or make establishment-specific service requests using a portable computing device on their person, for example a mobile phone. In some such embodiments, the establishment-specific information and/or establishment-specific service requests are seating-location specific. In this way a patron of an establishment may request information, and/or place orders, and/or request service, from the specific establishment to his or her specific seating location within the establishment.

### SUMMARY

Embodiments of the present invention enable an establishment-based patron tracking and messaging system in which individual customers of commercial establishments are enabled to send a coded message to a centralized server indicating their attendance within the particular establishment at a particular moment in time. Such attendance messages are received, decoded, and processed such that each individual patron's attendance within a particular commercial establishment is documented in a patronage database. In addition, in response to each of a plurality of received attendance messages, a randomized promotional offer process is performed in which each patron who sends such an attendance message is provided a statistical chance of winning a free or discounted product and/or service of that establishment. If the user wins, the promotional offer is conveyed to the patron as a return electronic message that is transmitted to his or her portable computing device. The patron may then redeem the free or discounted product or service within the establishment. In common embodiments, the promotional offer is time-limited such that it must be redeemed within the establishment within a very limited amount of time, thus ensuring that only patrons who are actually within or substantially near the establishment at the time the offer is received may redeem the offer.

Thus, upon entering a particular establishment, a patron may send an electronic message to the centralized patron tracking and messaging server, the electronic message indicating that user's presence within the particular establishment. In response to receiving the electronic attendance message, the centralized server determines based upon a statistical chance process if the particular patron wins an electronic promotional offer for that particular establishment. The statistical chance may be configured, for example, to statistical odds of approximately one in ten. Thus when a user sends an attendance message to the centralized server indicating his or her presence within a particular establishment, the patron has a one in ten chance of being awarded a free or discounted product or service of that establishment. The chance of winning the electronic promotional offer thus provides an incentive to customer to send the electronic attendance message to the centralized server. In this way customers are encouraged to inform the centralized server of their patronage of particular establishments, thus enabling of a more comprehensive tracking database of customer patronage.

In one example embodiment, a customer enters a restaurant or bar, sends an electronic message from a portable computing device on his or her person to the centralized server indicating their attendance, and then has a one in ten chance of winning a free beverage from that establishment. An electronic message is returned to the portable computing device of the patron, informing if he or she won the promotional offer. If so, the promotional offer is conveyed as an electronic award message that is redeemable within the establishment. To discourage customers from sending electronic attendance messages when they are not actually present within the establishment, the promotional offer may be time-limited, being redeemable at the establishment for a short period of time, for example a period of minutes. Thus physical presence within a period of minutes is required for redemption.

The system operates in some embodiments through methods, systems, and apparatus that enable a centralized establishment-based patron tracking server to monitor of the presence of particular users, each indexed by a unique User ID, within each of a plurality of localized physical establishments, each indexed by unique Establishment ID. More specifically, the centralized establishment-based server is configured to receive electronic attendance messages from the portable computing devices of each of a plurality of users who are currently patronizing each of a plurality of establishments, each attendance message indicating that a particular user is currently present within a particular establishment. In a common embodiment the portable computing devices are mobile phones of users and the electronic attendance messages are SMS text messages sent from the mobile phones of each user to the centralized server, the SMS messages including an encoded indication of the Establishment ID of the establishment that the sending user is currently patronizing. In response to receiving such messages, the centralized establishment-based patron tracking and messaging server maintains a data store, referred to herein as an establishment attendance database, the data store indicative of which of a plurality of individual users are believed to be currently present within which of a plurality of individual physical establishments.

In response to the receipt of an Attendance Message from a particular user relating to a particular establishment, the present invention is configured to run a randomized promotional offer process in which the particular customer has a limited statistical chance of winning a free or discounted product or service of the particular establishment. The results of the randomized promotional offer process are conveyed back to the user as return electronic message to his or her portable computing device. For example, if a user is determined to win a free or discounted product or service of an establishment, an electronic award message is sent to the portable computing device of that user indicating the win. In one such embodiment the results of the randomized promotional offer process are conveyed as an SMS text message to the portable computing device of the user indicating if the user has won and/or what the user has one. The electronic message may include a password or other code that is redeemable within the establishment for the awarded free or discounted product or service. The redemption may be time-limited such that the user can only receive the free or discounted product or service for a short time period following the transfer or receipt of the electronic message. In some embodiments the short time period is a number of minutes, such as ten minutes.

In some embodiments the randomized process is configured with substantially pre-set odds such that each user is provided a particular statistical chance of winning a free product or service for a particular establishment as a result of sending an Attendance Message to the centralized server relating to that particular establishment. In one example embodiment the free product or service is a free drink, desert, or appetizer of the establishment and the substantially pre-set odds are a one-in-ten chance. In this way a patron may arrive in a restaurant or bar establishment, send an electronic Attendance Message to the centralized server, and have a one-in-ten chance of winning a free drink, desert, or appetizer of the establishment. This provides an incentive for users to send the Attendance Message upon arrival within an establishment, thus enabling the centralized server to track the patronage behavior of a large plurality of customers to a large plurality of establishments.

To prevent patrons from repeatedly sending Attendance Messages with respect to a single establishment so as to increase their chances of winning a promotional offer during the may be configured such that a user is only considered for the promotional offer based upon a single Attendance Message for a particular establishment over a particular period of time. In some embodiments this period of time is referred to herein as “no_repeat_offer_time.” In this way a user cannot repeatedly send attendance messages for a particular establishment as a means of increasing odds over of winning the promotional offer within the no_repeat_offer_time. In some embodiments the no_repeat_offer_time is set to one hour. In some embodiments the value is configurable for each establishment, each establishment having a unique no_repeat_offer_time variable associated with it.

To prevent particular individual patrons from repeatedly winning multiple promotional offers within a period of time for a particular establishment, in some embodiments the centralized establishment-based tracking server performs a process such that the same user may not win the same promotional offer for the same establishment more than once within a particular period of time referred to herein as “no_repeat_win_time.” In this way a user cannot repeatedly win a particular promotional offer within a particular establishment within the no_repeat_win_time. In some embodiments the no_repeat_win_time is set to one week. In some embodiments the value is configurable for each establishment, each establishment having a unique no_repeat_win_time variable associated with it.

In some embodiments of the present invention the statistical chance that a patron has of winning a promotional award for a particular establishment is based at least in part upon the historical record of patronage of that user within respect to that establishment. In one such embodiment the user's chance of winning a promotional award is increased based upon a higher number or frequency of documented visits to that establishment during a prior period of time. In this way a frequent visitor to an establishment may be provided a higher statistical chance of winning a promotional award for that establishment than a less frequent visitor to that establishment.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 illustrates a system is comprised of an establishment-based patron tracking and messaging application running on a server or a group of servers according to an embodiment of the invention;

FIG. 2A illustrates a portable computing device configured with appropriate hardware and software according to an embodiment of the invention;

FIG. 2B illustrates a portable computing device of user, the portable computing device displaying a greeting message and establishment-specific promotional offer, to the user, on a screen according to an embodiment of the invention;

FIG. 3 illustrates a flowchart of an example process that supports the maintenance of the Establishment Attendance Database based upon received Attendance Messages and tracking of attendance time_outs for particular establishments according to an embodiment of the invention; and

FIG. 4 illustrates a process for returning Greeting Messages and/or Promotional Offers to the portable computing devices of patrons in response to the receipt of an Attendance Message according to an embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Embodiments of the present application are directed toward various embodiments of establishment-based patron tracking and messaging methods, apparatus, and computer program products that enable additional features and functions. In particular, embodiments of the present invention enables establishment-specific promotional offers to be awarded and transmitted to the portable computing devices of patrons of particular establishment in dependence upon a process of statistical chance that provides limited statistical odds of an award to that patron. In this way a patron can send an Attendance Message from a portable computing device on their person to the centralized server, the Attendance Message conveying their current patronage of a particular establishment, and receive in return, based at least in part on a process of statistical chance, a promotional offer relating to and redeemable within that particular establishment. The benefits of such features and functions will become apparent herein.

Embodiments of the invention are directed to methods, systems, and apparatus for enabling an establishment-based patron tracking and messaging server that receives electronic Attendance Messages from each of a plurality of portable computing devices of individual users, each attendance message indicating an individual user's attendance within one of a plurality of localized physical establishments. In response to receiving such attendance messages, the centralized establishment-based patron tracking and messaging server returns an electronic Greeting Message to the portable computing device of the user and optionally an electronic Promotional Offer award message to the portable computing device of the user, the promotional offer message conveying a free or discounted product or service of the establishment. The promotional offer message is awarded to the user based at least in part upon a process of chance such as, for example, a randomization selection process with substantially predefined odds. In one such embodiment the substantially predefined odds is approximately one-in-ten odds. In this way a user may arrive in a particular establishment, send an electronic Attendance Message to a centralized server indicating his or her attendance within the particular establishment, and is provided a statistical chance (for example one-in-ten odds) of be awarded an electronic promotional offer that is redeemable within the establishment for a free or discounted product or service of the establishment. The awarded promotional offer is conveyed to the user as an electronic message that is sent directly to the portable computing device of the user. In some embodiments, the electronic promotional offer is time-limited, meaning that is only redeemable within the establishment for a predetermined time period following the sending and/or receipt of the electronic award message. In some embodiments the electronic award message of the promotional offer includes an authentication code or value that enables it to be validly redeemed by the particular user within the particular establishment.

It has been determined to be valuable for commercial establishments, especially food and drink establishments, to maintain a record of the patronage of their customers, where the record includes an indication of who visited the establishment, when they visited, how many times they visited, and/or their frequency of their visits. It is also valuable for commercial establishments to encourage visit frequency among customers through real-time promotional offers, such as free or discounted products or services that may attract customers into the establishment when business is slow. Embodiments of the present invention provide for a centralized computer server to handle such functions in a substantially automated manner, employing a unique message passing process between portable computing devices of patrons (such as their mobile phones) and a centralized computer server that may be messaged from portable computing devices (for example over cellular networks). In some embodiments the unique message passing process involves text messaging to and from the mobile phones of patrons. Embodiments of the present invention enable a unique random chance process in which customers are enticed to inform establishments as to their presence (using their portable computing devices) in exchange for having a statistical chance of winning a free or discounted product or service. In this way, embodiments of the present invention provide for a unique method of tracking the patronage of customers by encouraging customers to inform a centralized server as to their attendance within an establishment as well as a unique method of messaging patrons with real-time offers.

As is described herein, embodiments of the present invention enable an establishment-based patron tracking and messaging system in which individual customers of commercial establishments are enabled to send a coded message to a centralized server indicating their presence within the particular at a particular moment in time. Such attendance messages are received, decoded, and processed such that each individual patron's attendance within a particular commercial establishment is documented in a patronage database accessible to the centralized server. In response to each of a plurality of received attendance messages, a randomized promotional offer process is performed in which individual patrons who send such an attendance messages are each provided a statistical chance of winning a free or discounted product and/or service of that establishment. If the user wins, the promotional offer is conveyed to that patron as a return electronic message that is transmitted to his or her portable computing device. The patron may then redeem the free or discounted product or service within the establishment. In some common embodiments, the promotional offer is time-limited such that it must be redeemed by physical presence within the establishment within a very limited amount of time, thus ensuring that only patrons who are actually within or substantially near the establishment at the time the offer is received will be able to redeem the offer.

In a common embodiment, the present invention is configured such that upon entering a particular establishment, a patron may send an electronic message to the centralized establishment-based patron tracking and messaging server, the electronic message indicating that user's presence within the particular establishment. In response to receiving the electronic attendance message, the centralized server determines, based at least in part upon a statistical chance process, whether or not the particular patron wins an electronic promotional offer for that particular establishment. The statistical chance may be configured, for example, to comprise statistical odds of approximately one in ten. Thus, when a user sends a valid attendance message to the centralized server indicating his or her presence within a particular establishment, the patron has a one in ten chance of being awarded a free or discounted product or service of that establishment. The chance of winning the electronic promotional offer thus provides an incentive to customer to send the electronic attendance message to the centralized server. In this way customers are encouraged to inform the centralized server of their patronage of particular establishments, thus enabling a more comprehensive tracking database of customer patronage. In other words, it is a win-win scenario wherein patrons are encourage to inform the centralized server of their patronage status for it may result in winning a free or discounted product or service. Establishments may be encouraged to offer a free or discounted product or service to a certain percentage of users who send attendance messages, for it will result in the establishment having access to a comprehensive data store of attendance patronage. In addition, the comprehensive data store may be used to send future promotional messages directly to the mobile phones of past patrons, as is described in detail in co-pending U.S. Patent Application Ser. No. 60/918,772, which is incorporated herein by reference in its entirely.

In one example embodiment of the present invention, a customer enters a restaurant or bar, and sends an electronic message from a portable computing device on his or her person to the centralized establishment-based patron tracking and messaging server, where the electronic message indicating their attendance within the particular establishment. In response, the centralized server determines if the patron has won a promotional award for a free product or service of the establishment. In this embodiment, the centralized server is configured to give the patron a one in ten chance of winning a free beverage from that establishment. An electronic message is returned to the portable computing device of the patron, informing if he or she won the promotional offer. If so, the promotional offer is conveyed as an electronic message that is redeemable within the establishment. To prevent customers from sending electronic message of this sort when they are not actually present within the establishment, the promotional offer may be time-limited, being redeemable at the establishment for a short period of time, for example, within a period of minutes. Thus, physical presence within a period of minutes is required for redemption within the limited time period.

The system operates in some embodiments through methods, systems, and apparatus that enable a centralized establishment-based patron-tracking server to monitor of the presence of particular users, each indexed by a unique User ID, within each of a plurality of localized physical establishments, each indexed by unique Establishment ID. More specifically, the centralized establishment-based tracking server is configured to receive electronic attendance messages from the portable computing devices of each of a plurality of users who are currently patronizing each of a plurality of establishments, each attendance message indicating that a particular user is currently present within a particular establishment. In a common embodiment the portable computing devices are mobile phones of users and the electronic attendance messages are SMS text messages sent from the mobile phones of each user to the centralized server, the SMS messages including an encoded indication of the Establishment ID of the establishment that the sending user is currently patronizing. In response to receiving such messages, the centralized establishment-based server maintains a data store, referred to herein as an “establishment attendance database,” where the data store is indicative of which of a plurality of individual users are believed to be currently present within which of a plurality of individual physical establishments.

In response to the receipt of an Attendance Message from a particular user relating to a particular establishment, the centralized server is configured to execute a randomized promotional offer process in which the particular customer has a limited statistical chance of winning a free or discounted product or service of the particular establishment. For example, the promotional offer process may be configured to provide a particular user with a one in ten chance of winning a particular promotional offer that is redeemable within a particular establishment. The results of the randomized promotional offer process are then conveyed back to the user as return electronic message to his or her portable computing device. In one such embodiment the results of the randomized promotional offer process are conveyed as an SMS text message to the portable computing device of the user indicating if the user has won and/or what the user has one. The electronic message may include a password or other code that is redeemable within the establishment for the awarded free or discounted product or service. The redemption may be time-limited such that the user can only receive the free or discounted product or service for a short time period following the transfer or receipt of the electronic message. In some embodiments the short time period is a number of minutes, such as ten minutes. In many preferred embodiments the user must be physically present, with his or her portable computing device, in order to redeem the promotional offer within the time period. In this way only customers who are actually present within and/or may become present within a very short time period, may redeem the time-limited promotional offer.

In some embodiments the randomized process is configured with substantially pre-set odds such that each user has a particular statistical chance of winning a free product or service for a particular establishment as a result of sending an Attendance Message to the centralized server relating to that particular establishment. In one example embodiment the free product or service is a free drink, desert, or appetizer of the establishment and the substantially pre-set odds are a one-in-ten chance. In this way a patron may arrive in a restaurant or bar establishment, send an electronic Attendance Message to the centralized server, and have a one-in-ten chance of winning a free drink, desert, or appetizer of the establishment. This provides an incentive for users to send the Attendance Message upon arrival within an establishment, thus enabling the centralized server to track the patronage behavior of a large plurality of customers to a large plurality of establishments.

To prevent patrons from repeatedly sending Attendance Messages with respect to a single establishment so as to increase their chances of winning a promotional offer during the may be configured such that a user is only considered for the promotional offer based upon a single Attendance Message for a particular establishment over a particular period of time. In some embodiments this period of time is referred to herein as “no_repeat_offer_time.” In this way a user cannot repeatedly send attendance messages for a particular establishment as a means of increasing odds over of winning the promotional offer within the no_repeat_offer_time. In some embodiments the no_repeat_offer_time is set to one hour. In some embodiments the value is configurable for each establishment, each establishment having a unique no_repeat_offer_time variable associated with it. Because each establishment is configured with a unique establishment ID, the centralized establishment-based patron tracking and messaging server may maintain a data structure for no_repeat offer_time that is indexed with respect to each of a plurality of unique establishment. Such a data structure may take the basic format:
no_repeat_offer_time (Establishment_ID)

To prevent particular individual patrons from repeatedly winning multiple promotional offers within a period of time for a particular establishment, in some embodiments the centralized establishment-based tracking server performs a process such that the same individual user (indexed by unique User ID) may not win the same or similar promotional offer for the same establishment more than once within a particular period of time. Such a particular period of time is referred to herein as “no_repeat_win_time.” In this way a user cannot repeatedly win a particular promotional offer within a particular establishment within a time period that is less than the no_repeat_win_time. In some embodiments the no_repeat_win_time is set to one week. In some embodiments the no_repeat_win_time is set to other durations, for example, one day, two days, two weeks, or one month. In some embodiments the value is configurable for each establishment, each establishment having a unique no_repeat_win_time variable associated with it. Because each establishment is configured with a unique establishment ID, the centralized establishment-based patron tracking and messaging server may maintain a data structure for no_repeat_win_time that is indexed with respect to each of a plurality of unique establishment. Such a data structure may take the basic format:
no_repeat_win_time (Establishment_ID)

In some such embodiments, a plurality of separate promotional offers may be relationally associated with a particular establishment. In some such embodiments, each of the plurality of separate promotional offers may be assigned a separate no_repeat_win_time. In a common embodiment, the more valuable a redemption value of a promotional offer, the longer the no_repeat_win_time associated with it. In such embodiments, each promotional offer within the establishment may be assigned a separate Promotional_Offer_Index value. In such embodiments the data structure user may be:
no_repeat_win_time (Establishment_ID, Promotional_Offer_Index)

As discussed above, a particular statistical chance may be assigned to a promotional offer that at least in part, governs the odds that an individual user has in winning the promotional offer upon transmitting an Attendance Message to the centralized server. This value may be assigned a variable name such as “win_chance_value.” This value may be represented as a fraction, for example 1/10 may be used to represent a 1 in 10 odds chance of winning. A 1/25 fraction may be used to represent a 1 in 25 chance of winning. Each establishment may set its own statistical chance with respect to a promotional offer that is awarded to patrons who send Attendance Messages for that establishment and that is redeemable within that establishment. Thus, a data structure may be used to set the statistical chance that an individual patron wins the promotional offer upon sending a valid Attendance Message, as follows:
win_chance_value (Establishment_ID)

In some such embodiments, a plurality of separate promotional offers may be relationally associated with a particular establishment. In some such embodiments, each of the plurality of separate promotional offers may be assigned a separate win_chance_value. In a common embodiment, the more valuable a redemption value of a promotional offer, the lower the odds of winning in the win_chance_value associated with it. In such embodiments, each promotional offer within the establishment may be assigned a separate Promotional_Offer_Index value. In such embodiments the data structure user may be:
win_chance_value (Establishment_ID, Promotional_Offer_Index)

In some embodiments of the present invention the statistical chance that a patron has of winning a promotional award for a particular establishment is based at least in part upon the historical record of patronage of that user within respect to that establishment. In one such embodiment the user's chance of winning a promotional award is increased based upon a higher number or frequency of documented visits to that establishment during a prior period of time. In this way a frequent visitor to an establishment may be provided a higher statistical chance of winning a promotional award for that establishment than a less frequent visitor to that establishment.

With respect to the overall system architecture disclosed herein, as well as in the aforementioned co-pending patent applications by the present inventor, an establishment-based patron tracking and messaging (EBPTM) service is enabled that is moderated by a centralized server. The centralized server is operative to document the presumed current attendance of each of a plurality of individual users, each indexed by a unique User ID, within each of a plurality of localized physical establishments, each indexed by unique Establishment ID. The EBPTM server also enables the passing of establishment-specific messages to and from the portable computing devices of users at least in part upon their documented attendance within particular physical establishments. The EBPTM server also enables users to request of establishment-specific services by sending service requests from personal portable computing devices on their person, to the centralized server, where the service requests are relationally associated with the establishment that the requesting user is documented as being currently present within. In certain preferred embodiments, a user sends an electronic message from a portable computing device on his or her person, to the EBPTM server, the electronic message indicating his or her current attendance within a particular localized physical establishment. In some such embodiments, the electronic message is an SMS text message that includes the unique Establishment ID of the particular localized physical establishment that the user is currently patronizing. Thus for example, a user may enter a particular physical establishment, send a quick text message to the EBPTM server, the text message including the unique Establishment ID of the particular establishment. The EBPTM receives the message, parses it, and in response documents the user's presence within the particular establishment. Once documented, the user's attendance within that establishment is used by the EBPTM server to facilitate establishment-specific message passing processes and/or establishment-specific service request processes. In the current invention, the user's attendance within the establishment is used to trigger a random chance process in which it is determined, based at least in part upon statistical odds, if the patron wins a free or discounted product or service within the establishment. If so, a return electronic message is sent to the portable computing device of the patron, indicating what was won. Also included in the message is a time-limitation value indicating within what time the user must redeem the offer (in person) for it to be valid. The return electronic message may also include an authentication code or password.

In these ways, the methods, apparatus, and computer program products disclosed herein follow a “tell us you're here” patron tracking methodology in which electronic messages are sent to the EBPTM server indicating the attendance of particular individual users (each indexed by unique User ID) within particular physical establishments (each indexed by unique Establishment ID). Each of such messages is referred to herein as an “attendance message” and comprises an electronic message sent to the centralized EBPTM server containing a unique Establishment ID of a unique localized physical establishment and an indication as to which user is being identified as being currently present within the establishment. Based up the receipt of a plurality of such attendance messages, the central server stores an in memory an indication of the presumed attendance of each of a plurality of particular users within each of a plurality of particular establishments. Such a data store of presumed customer attendance within each of a plurality of localized physical establishments is referred to herein as an Establishment Attendance Database.

In some embodiments a time-out period is defined for each establishment, the time-out period indicating how long after a last attendance message is received relating to the particular establishment that the user is documented as currently patronizing the particular establishment within the Establishment Attendance Database. In some such embodiments, a particular user is documented in the Establishment Attendance Database as being present within a particular localized physical establishment for an extended period of time following the receipt of an attendance message relating to that particular localized physical establishment, the extended period of time being the shortest of (a) until the time-out period of that particular establishment has elapsed following the receipt of the attendance message, (b) until a new attendance message has been received indicating that the particular user is now present within a different localized physical establishment, or (c) until an exit message is received indicating that the user has specifically exited the particular localized physical establishment. In this way the routines of embodiments of the present invention may be configured to document a particular user as being present within a particular establishment for an extended period of time following a received attendance message indicating that the particular user is present within the particular establishment, the extended period of time ending upon the first of (a) an expired time-out period, (b) the receipt of a new attendance message indicating that the particular user is now present within a different particular establishment, and (c) the receipt of an exit message indicating that the user has exited the particular establishment.

The Establishment Attendance Database may also include historical data indicating the patronage history of particular users with respect to particular establishment, documenting for example which establishments have been visited by which users, when the visits happened, and how long the visits lasted. The portion of the establishment attendance database that documents the current patrons who are believe to be present within a particular establishment is referred to herein as the Establishment User List for the particular establishment at a particular moment in time. The portion of the establishment attendance database that documents previous patrons of a particular establishment over a period of time is referenced to as the Establishment Patronage History for the particular establishment. The portion of the establishment attendance database that documents for each of a plurality of particular users, the localized physical establishments that the user has been documented as visiting over a period of time is referred to as the User Patronage History for that particular user.

In addition, an Establishment Information Database may be maintained accessible to the EBPTM server. The Establishment Information Database contains establishment-specific information including “descriptive information, service information, current demographic profile information” relating to each of a plurality of indexed establishments. Thus, the Establishment Information Database may comprise product information, menu information, promotional offer information, promotional message information, and/or service information, relating to that particular establishment, and indexed with respect to the unique Establishment ID of that particular establishment. The Establishment Information Database may also include a plurality of unique promotional offers for that establishment, each indexed by a unique promotional_offer_index. Each promotional offer may be assigned its own unique win_chance_value as well as its own unique no_repeat win_time, as described above. In addition, each unique promotional offer may have one or more unique password or authorization codes associated with it, stored in memory with respect to its promotional_offer_index.

In addition, the EBPTM server maintains user data about each of a plurality of individual users of the Establishment-Based Patron Tracking and Messaging Service, the user data including personal profile information and customer account data. The personal profile information generally includes demographic characteristics for each of the plurality of individual users such as that user's age, gender, highest level of schooling, marital status, political affiliations, school affiliations, team affiliations, club affiliations, organizational affiliations, hobbies, interests, profession, job title and/or hierarchy level within an organization, sexual orientation, annual income, sporting team preferences, status as a tourist or resident within the current geographic region, relationship status (i.e. whether in a relationship or looking for a relationship), musical preferences, IQ, entertainment preferences, food and drink preferences, clothing preferences, brand preferences, and/or other similar personal characteristics. The personal profile information may also include user body height information, user body weight information, user pants size information, user shirt size information, and/or user shoe size information. More specifically, the EBPTM server as disclosed herein may be configured to maintain and/or access a database of personal profile information for each of a plurality of users, the personal profile information for each user being referenced by a unique user ID or other unique identifier for each user by which the information for that user is indexed. Such a database is referred to herein as a Personal Profile Database. In addition, customer account data may be stored for each user reflecting a number of credits and/or a billing balance assigned to the user.

Establishment-Based Messaging is provided according to various embodiments. By using the relational associations between users and establishments as stored within the Establishment Attendance Database, embodiments of the present invention are operative to enable establishment-specific messages to be sent to and from the portable computing devices of particular users based at least in part upon the particular establishment said users are documented as patronizing. In some embodiments the establishment-specific messages sent to the portable computing devices of users who are currently patronizing particular establishments. In some embodiments the establishment-specific messages are sent to the portable computing devices of users who have previously patronized particular establishments. In some embodiments the establishment-specific messages are sent to the portable computing devices of users based upon a combination of (a) the establishment they are documented as currently patronizing and (b) historical data indicating previous patronage by the user of one or more establishments. In this way, for example, a current customer of an establishment may be messaged, directly to a portable computing device on his or her person, with a message relating to a particular establishment, based at least in part upon his or her current patronage of the establishment as well as historical data about his or her pervious patronage of the establishment. In one example embodiment, a user is sent a message relating to a particular establishment based at least in part upon the fact that (a) he is currently documented as being within the establishment, and (b) he is historically documented as having visited the establishment more than five times in the last 12 months. Thus, embodiments of the present invention enable establishment-specific messages to be sent to particular patrons of establishments in a highly targeted and customized manner. In some embodiments the promotional messages sent to users relating to a particular location based establishment are accessed from the Establishment Information Database by indexing the unique Establishment ID of the particular establishment. The portion of the Establishment Information Database containing promotional messages and/or offers is referred to herein as the Promotional Messaging Database.

In some embodiments the establishment-specific promotional messages sent to the portable computing devices of current and/or past patrons of particular establishments are establishment-specific promotional offers redeemable for free or discounted products or services of the particular establishment to which it relates. For example, an establishment specific promotional offer relating to a particular restaurant establishment may comprise an offer for a free appetizer, drink, entrée, or desert within that establishment. In some such embodiments the promotional offers are time-limited, being valid for redemption within the particular establishment within a defined time period following receipt by the portable computing device of a particular user. In an example scenario, an establishment-specific promotional message sent to a user is a time-limited promotional offer, the time-limited promotional offer being sent to a previous patron of a particular restaurant. The time-limited promotional offer may comprise, for example, an offer for a free appetizer, redeemable within the next 45 minutes. In this way a previous patron of a particular establishment may receive a real-time message directly upon his or her portable computing device (i.e. mobile phone), indicating that if he or she arrives within the particular establishment within the next 45 minutes, he or she can receive a free appetizer. Such a promotional offer thus has the ability to motive the receiving patron to visit the particular establishment in a timely manner. In his way the EBPTM server provides the establishment with a service such that it may request the transmission of real time promotional messages, that are time-limited and thus time motivating, to previous patrons of that establishment, directly to the mobile phones or other portable computing devices of those patrons, based at least in part upon the stored patronage history in the Establishment Attendance Database.

Establishment-Based Services are provided according to various embodiments. Embodiments of the present invention are operative to enable establishment-specific services to be requested and/or delivered to and/or from particular users based at least in part upon the particular establishment the particular user is documented as patronizing within the Establishment Attendance Database. For example, a patron of an establishment may request a menu from the EBPTM server. Because the EBPTM server maintains data documenting what establishment the user is currently patronizing, each indexed by unique user ID, the EBPTM server may access a menu for the establishment the user is currently patronizing from the Establishment Information Database, indexing that database with the Establishment ID of the establishment that the user is documented as currently patronizing. In this way, a user may enter an establishment, send an Attendance Message to the EBPTM server indicating that he or she is currently present within the particular establishment (by conveying the unique Establishment ID for that establishment). The EBPTM serve then maintains a record of that particular user (indexed by unique User ID) as being present within that particular establishment (indexed by unique Establishment ID). Then, at a later time, but before the time-out period has expired, that particular user may send a “menu request” message to the EBPTM server. The user need not re-identify a particular establishment because the user has already informed the EBPTM server as to his or her current patronage. Thus the user may simply send a generic “menu request” message to the EBPTM server, the server accessing the Establishment Patronage Database and access a record for the requesting user indicating the unique Establishment ID of the establishment he is currently patronizing. The EBPTM server then accesses the Establishment Information Database, using that unique Establishment ID, retrieves the menu for that particular establishment, and returns it as an electronic message to the requesting patron. In this way the patron was able to request a menu, as he would be able to request other information and/or services, relating to the particular establishment, without needing to re-identify the establishment. This is a substantial value of the “tell us you're here” methodology. where the EBPTM server maintains a data store documenting the current patronage of a plurality of users, indexed by unique user ID and unique establishment ID. Additional establishment-specific information requests and/or service requests are disclosed in the plurality of co-pending patents incorporated herein by reference. Most such services can benefit from the patronage tracking database described herein, reducing the amount of information that need be exchanged between patrons and the central server.

In addition, embodiments of the present invention may be configured to enable person-to-person messaging to be performed with message delivery being dependent, at least in part, upon the documented presence of the receiving patron within a particular localized physical establishment. In such embodiments a message may be sent from a computing device of a first user to a portable computing device of a second user, the message being addressed with a unique electronic address of the second user and with a unique establishment ID (or group of establishment ID's) that define the location(s) for which the second user must be believed present for the electronic message to be delivered. In this way, a first user may send a message to a second user, for example, by texting a message to the phone number of the second user and to the Establishment ID of a particular coffeehouse where the second patron visits. The EBPTM server holds the message in memory, delivering it to the portable computing device of the second user the next time the server receives an Attendance Message indicating that the second user is present within the particular coffeehouse. This creates a fun process in which users may send electronic messages to other users, link the messages to specific establishments (e.g., restaurants, coffeehouses, retail stores, bars, or theaters), such that the messages are delivered dependent upon determinations of establishment-specific presence of the second user within the related establishment(s). A more detailed disclosure of person-to-person establishment-based messaging is described in co-pending Provisional Application Ser. No. 60/925,038, filed Apr. 14, 2007, which is incorporated herein by reference in its entirely.

In addition, embodiments of the present invention may be configured to enable personal reminder messaging in which a user composes a reminder message for himself or herself, the reminder messages being delivered and/or displayed to the user dependent, at least in part, upon the documented arrival and/or presence of the user within a particular localized physical establishment. In such embodiments a reminder message may be stored accessible to the EBPTM server, relationally associated with a unique establishment ID (or group of establishment ID's) that define the location(s) for which the user must be believed present for the reminder message to be delivered. The EBPTM server holds the message in memory, delivering it to the portable computing device of the user the next time the server receives an Attendance Message indicating that the user is present within an establishment relationally associated with the reminder message. This creates a useful process in which users may send reminder messages to themselves and link the messages to specific establishments such that the messages are delivered dependent upon determinations of establishment-specific presence of the user within the related establishment(s). A more detailed disclosure of establishment-based reminder messaging is described in co-pending patent applications by the present inventor, including application Ser. No. 11/551,720, which is incorporated herein by reference in its entirely.

In some such embodiments a user may request information indicating if any friends and/or acquaintances are currently documented as being present within a particular localized physical establishment by sending a patronage profile request to the EBPTM server relating to a particular localized physical establishment. In general the user sends a patronage profile request to the EBPTM server, the request including the unique establishment ID of the establishment for which the user desires current patronage profile information. The current patronage profile information that is returned to the computing device of the user, by the EBPTM server may be numerical, for example including an indication of the number of friends and/or acquaintances present within the establishment, or may include a listing of unique identifiers for each friend or acquaintance that is currently present within the establishment. In one embodiment that supports such features, the Personal Profile Information stored for each user includes a Friends List that indicates a plurality of other users, by unique ID of each, that the profiled user considers friends. Thus when that user sends a patronage profile request to the EBPTM server, the server accesses the Establishment User List for that establishment, accesses the Friends List for that user, and determines if any of the users who are listed on the Friends List for that user, are currently present on the Establishment User List for that establishment. If so, the EBPTM server returns a message to the computing device of the requesting user, informing the requesting user as to the number or percentage of friends who are present within the identified establishment and/or returns a message with a listing of the friends, by name or handle or unique ID, who are present within the identified establishment. In this way, a user may send a patronage profile request to the EBPTM server, including the unique Establishment ID of a particular coffeehouse, and be returned an electronic message that includes a listing of any friends of that user who are currently present within that coffeehouse. In addition the user may request statistical information about the current patronage of the identified establishment, for example the total number of patrons currently present, the percentage of patrons who are a particular gender, the percentage of patrons who are single, and/or the percentage of patrons who are of a particular age group, and/or the percentage of patrons who are identified as being members of a particular club, group, team, or school. More detailed disclosures of establishment-based patronage profiling is described in co-pending patent applications by the present inventor, including patent application Ser. No. 11/383,197, and Provisional Application Ser. Nos. 60/723,021, 60/918,772, and 60/928,729, which are all incorporated herein by reference in their entirely.

In many preferred embodiments, the portable computing devices of users are mobile telephones of the individual users and the electronic messages are SMS text messages. In some such embodiments, an individual user sends a text message from his or her mobile phone, to the EBPTM server, the SMS text message including within the content a representation of the unique Establishment ID of the particular establishment that the user has just arrived in and/or is currently present within. Thus, embodiments of the present invention enable an individual user, upon arrival within a localized physical establishment, to type into his or her mobile phone the unique Establishment ID of the physical establishment and send it as a text message to the patron tracking server, thereby informing the server that the particular user is now currently present within the particular establishment. Thus the user has performed the “tell us you're here” process, informing the server that he or she is “here” (i.e., physically present) within the localized physical establishment that is relationally associated with the unique Establishment ID. The unique identity of the particular user is determined either by a unique user ID that is included within the content of the SMS text message and/or by a unique electronic address of the portable computing device from which the message was received. In this way the establishment-based patron tracking server is operative to receive “tell us you're here” messages from each of a plurality of individual users, each “tell us you're here” message indicating the presence of a particular user within a particular localized physical establishment. The establishment-based server is then operative, based upon such received messages, to maintain an Establishment Attendance Database of patron tracking information, the database documenting the presumed presence of each of a plurality of individual users within each of a plurality of particular localized physical establishment.

In some such embodiments, the users are informed of the unique Establishment ID of an establishment based upon visually posted signs and/or placards within the establishment. For example, a sticker upon the door of the establishment is posted that includes the unique Establishment ID of that establishment. The ID may include a unique identifying mark or symbol such that a user can easily recognize it as an Establishment ID. In some such embodiments the unique symbol is a leading and trailing pound sign, such that a sticker with the symbol #104324# would be easily identified by a user as an Establishment ID sticker for the establishment, the Establishment ID being the unique value 104324. Thus, a user, upon viewing the sticker or other similar visual display within the establishment, may type in the value 104324 into his or her mobile phone, may text message it to the EBPTM server, and may thereby send an Attendance Message to the server indicating his or her arrival and/or presence within the particular establishment. This is a fast and easy process.

In other embodiments the Establishment ID may be conveyed electronically to the portable computing device of a user upon arrival and/or during presence within a particular establishment. As disclosed in, for example, co-pending patent application Ser. Nos. 11/383,197 and 11/422,065, the unique ID may be alternately conveyed, for example, by RFID scanner, bar code scanner, and/or other localized informational scanning and/or transmission technology. In addition, some embodiments enable individual users to also send a unique Seating Location ID to the EBPTM server, indicating a unique seating location of the particular user within the particular establishment that they are currently present within. The establishment-based patron-tracking server may then store within the Establishment Attendance Database, an indication of which seating locations, individual patrons are located within, when present within a particular establishment. Such methods are useful for establishments that have unique tables, seats, or other fixed seating locations.

It is within this context of establishment-based messaging and establishment-based services that the present features for randomized real-time promotional offers are enabled in response to received Attendance Messages. Many of the aforementioned features and services require a “tell us you're here” attendance message. To encourage patrons to send such messages, the randomized award process described herein gives patrons a statistical chance of winning a free or discounted product or service in response to sending an Attendance Message.

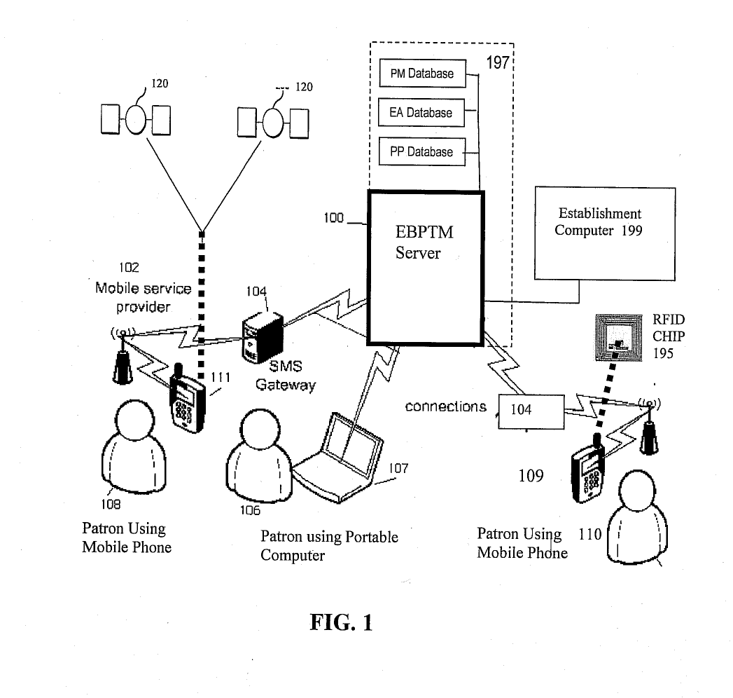

FIG. 1 illustrates a system is comprised of an establishment-based patron tracking and messaging application (i.e., EBPTM application) running on a server or a group of servers (i.e., EBPTM server) according to an embodiment of the invention. An example EBPTM server 100 running EBPTM software is shown in the figure provided. As described previously, the server may access one or more data stores that includes a plurality of databases in a data store 197, the databases including an Establishment Attendance Database (EA Database), a Personal Profile Database (PP Database) and a Promotional Messaging Database (PM Database), which is part of an Establishment Information Database as, described previously. Additional databases, not shown may also be included including a person-to-person messaging database and/or a personal reminder database, both of which may store a plurality of messages that are addressed to users based upon unique electronic address of their portable computing devices and based upon one or more localized physical establishments that they may visit in the future. As described previously, the Promotional Message Database may include a plurality of unique promotional offers for each unique establishment, each promotional offer indexed by the unique Establishment ID of that establishment and by a unique promotional_offer_index of that offer. Each promotional offer may be assigned its own unique win_chance_value as well as its own unique no_repeat_win_time, as described previously. In addition, each unique promotional offer may have one or more unique password or authorization codes associated with it, stored in memory with respect to its promotional_offer_index. In addition, the EBPTM database may maintain a data structure of no_repeat_offer_time values for each of a plurality of separate localized physical establishments, the no_repeat_offer_time for each establishment being indexed with respect to its each establishment's unique Establishment ID value. In addition, the EBPTM server may maintain a plurality of separate timer values, for example an Attendance Timer and a No Repeat Timer for each of a plurality of individual patrons of each of a plurality of separate localized physical establishments, as is described in detail below.

In addition, the EBPTM server runs a randomized promotional offer process in which individual patrons who send such an attendance messages relating to a particular localized physical establishment are each provided a statistical chance of winning a free or discounted product and/or service of that establishment. The statistical chance is based at least in part upon a stored variable, for example a win_chance_value of that establishment. If the user wins, the promotional offer is conveyed to that patron as a return electronic message that is transmitted to his or her portable computing device. The patron may then redeem the free or discounted product or service within the establishment. In common embodiments, the promotional offer is time-limited such that it must be redeemed by physical presence within the establishment within a very limited amount of time, thus ensuring that only patrons who are actually present will be able to redeem the offer.

The Establishment Information Database may also include one or more pre-planned Greeting Messages related to each unique establishment, indexed to the unique Establishment ID of that establishment. A Greeting Message may be a preplanned textual and/or graphical message that is sent to documented patrons of an establishment, in response to a received Attendance Message from a patron relating to the establishment, the Greeting Message welcoming the patron to the establishment. The Greeting Message may comprise, for example, a phrase such as “Welcome to Samurai Sushi”. As is described is further detail below, a patron who sends an Attendance Message to the EBPTMS that indicates the unique ID of an establishment, for example, the ID of the establishment called Samurai Sushi, will receive back a Greeting Message that is relationally associated with that establishment, for example “Welcome to Samurai Sushi.” This provides confirmation to the patron that he or she sent a valid and correct Attendance Message and that his or her patronage was documented as being within the correct establishment. In some embodiments the return Greeting Message may also provide the patron with some historical data about his or her patronage with respect to the identified establishment. For example, data may be returned and displayed about the number or frequency of visits that the patron has had to the establishment over a prior period of time. The data returned and displayed may also include information about the time period since the patron has last visited. For example, the Greeting Message may include a textual and/or graphical information display such as “This is your 8th visit this year” indicating to the user that his current visit is his or her eighth documented visit to the establishment during the current calendar year. The Greeting Message may also include a textual and/or graphical information display such as “We are glad to see you. You have not been here in 32 days,” thereby indicating the time period since the patron was last documented as visiting the establishment.

By maintaining the aforementioned Establishment Attendance Database in data store 197, the EBPTM application is operative to keep track of the patronage of each of a plurality of location-based establishments (not shown) by each of a plurality of patrons or users (108, 106, 110). As represented in FIG. 1, the EBPTM software application is operative to give a plurality of users (for example user 106, 108, 110), each using a portable computing device (107, 109, 111), the ability to inform the EBPTM server as to their arrival and/or attendance within a particular localized physical establishment as well as the ability receive establishment-specific promotional offers and/or request establishment-specific services. As described previously, a user (106, 108, 110) may use his or her portable computing device (111, 107, 109) to send an Attendance Message to the EBPTM server, the attendance message including the unique establishment ID of the establishment that he or she has arrived in and/or is present within. The EBPTM server parses the Attendance Message, extracting data from the content of the message and/or the electronic address of the sending portable computing device. In this way the EBPTM server determines from the Attendance Message, which user (by unique user ID) is physically patronizing within which establishment (by unique Establishment ID). An indication of this patronage is stored within the Establishment Attendance Database, optionally along with a time stamp for when the Attendance Message was received by the EBPTM server.

Each enabled portable computing device may run EBPTM client software that enables information exchange to and from the EBPTM server over a communication link, for example communication link 114 or through a gateway 104 to a mobile service provider. In some embodiments standard SMS text messaging protocols are used via manual user input, avoiding the need for custom EBPTM client software. In other embodiments SMS text messaging protocols are used under the control of a custom software application running upon the portable computing device. In some embodiments of the present invention, portable computing device (107, 109, 111) has access to locative data such as GPS data used for determining a current spatial location of the mobile computing device. GPS data is generally derived by a transceiver on board the mobile computing device that references orbiting satellites 120. In some embodiments a lookup table may be used to relate GPS locations to particular spatial boundaries that correspond to a particular localized physical establishment associated with a particular Establishment ID value. In some embodiments of the present invention, portable computing device (107, 109, 111) may access Establishment ID values electronically, for example using an RFID scanner, that accesses an RFID chip 195 and reads Establishment ID information from the chip. In such embodiments the chip may be located in a doorway of the establishment and is automatically accessed upon entry by the user.

Thus as illustrated in FIG. 1, the present invention may be implemented as a managed service (e.g., in an ASP model) using an EBPTM server 100, which is connected or connectable to one or more networks. As shown, the network may include a cellular network and/or other wireless network for communicating with each of a plurality of portable computing devices such as mobile phones. The network may also include the Internet for communicating with computers, such as an establishment computer 199 for each of a plurality of establishments. For illustrated purposes, the EBPTM server 100 is shown as a single machine, but one of ordinary skill will appreciate that this is not a limitation of the invention. More generally, the service is provided by an operator using a set of one or more computing-related entities (systems, machines, processes, programs, libraries, functions, or the like) that together facilitate or provide the inventive functionality described herein. In a typical implementation, the service comprises a set of one or more computers, an operating system (e.g., Linux, Windows, OS-X, or the like), an application runtime environment (e.g., Java, ASP) and a set of applications or processes (e.g., Java applets or servlets, linkable libraries, native code, or the like, depending on platform), that provide the functionality of a given system or subsystem. The service may be implemented in a standalone server, or across a distributed set of machines. Typically, a server connects to the publicly-accessible Internet, a private network, or any combination thereof, depending on the desired implementation environment. As illustrated FIG. 1, the EBPTM server 100 is also in communication with a mobile service provider (MSP) 102 through a gateway 104, such as SMS gateway or other similar pathway. In this way portable computing devices may communicate with the EBPTM server via cellular networks, Internet communication pathways, and/or SMS messaging pathways. In a preferred embodiment, SMS messaging is used for messaging between portable computing devices (109, 111) and the EBPTM server 100 because of its widespread usage on mobile phones.

As also illustrated in FIG. 1, one or more users 106 register for the service, typically by using a client machine which may be the portable computing device 111 or some other machines such as a personal portable computer 107. The registration process may include a user entering personal demographic data about themselves, for example their age, gender, marital status, organizational affiliations, school affiliations, musical tastes, food tastes, height, weight, shirt size, pants size, shoe size, listing of friends, favorite colors, and/or favorite product brands. The personal data may also include preferences about the types of promotional offers that the user wishes to receive from establishments. For example, a user may indicate a desire to only receive offers for free items with a certain value or more. In this way a user can avoid being bombarded with offers for items that are below the desired value threshold. In addition, the user can indicate the types of establishments and/or types of promotional offers that he or she is willing to receive. For example, the user may indicate that he or she is willing to receive promotional offers for free drinks, appetizers, deserts, and/or entrees at food and beverage establishments, but that the user is not willing to receive promotional offers for discounted clothing. This allows a user to manage through preference settings the type of offers and/or type of establishments from which promotional offers will be received.

As also illustrated in FIG. 1, each establishment that participates in the EBPTM service may have one or more Establishment Computers 199 that is in communication with the EBPTM server. The Establishment Computer 199 may be used by employees of the establishment to configure settings, define, select, and/or deploy establishment-specific promotional offers that are stored in the PM database, define and/or select the messaging rules by which the EBPTM server sends promotional offers to current and/or past patrons of the establishment, and/or to check the patronage profile of current and/or past patrons by accessing demographic statistics for the establishment. The Establishment Computer 199 may also be used to convey service requests from patrons of the establishment to employees of the establishment, the service requests being displayed upon a screen of the Establishment Computer 199 such that they may be viewed by employees of the establishment. In this way the EBPTM server enables a unique form of communication, both through messaging and service requests, between establishments and patrons of those establishments. Additional information about the routing of service requests is disclosed in co-pending patent application Ser. No. 11/422,065, which is incorporated herein by reference.

The Establishment Computer 199 is also used for managing promotional offer passwords and/or codes that validate the offers received by patrons on their portable computing devices. For example, in some embodiments a promotional offer sent to a portable computing device 111 of a patron, includes an authorization code that is used to validate the offer. A copy of the authorization code is also sent to an establishment computer 199 (and/or is accessible by an establishment computer 199) of the establishment for which the promotional offer relates. In this way an employee of the establishment may check that an authorization code presented by a customer matches an authorization code received by establishment computer 199 from the EBPTM server. In a common embodiment the authorization codes received by an establishment computer 199 from the EBPTM server may have a time-stamp or other time-limiting indicator, indicating the time period until when the promotional offer associated with the code is no longer valid. In this way employees of an establishment may check an authorization code presented by a customer with an authorization code received by the establishment computer to determine if it represents a valid offer that has been used within required time limits.

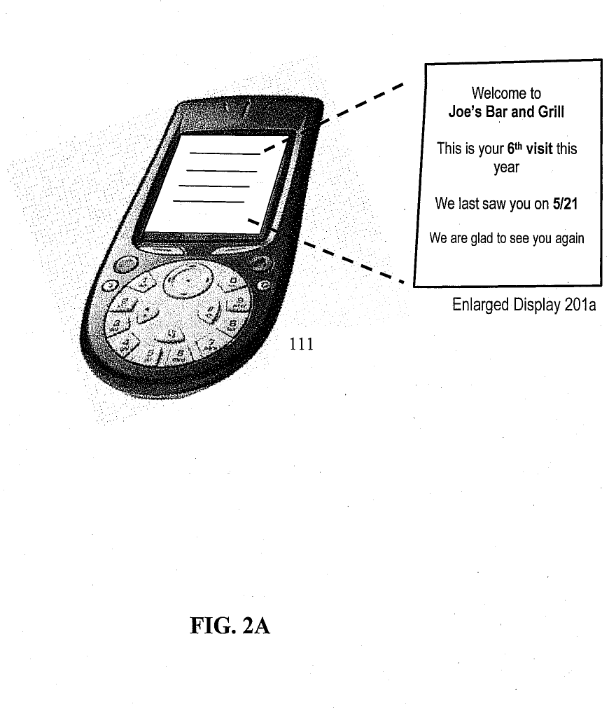

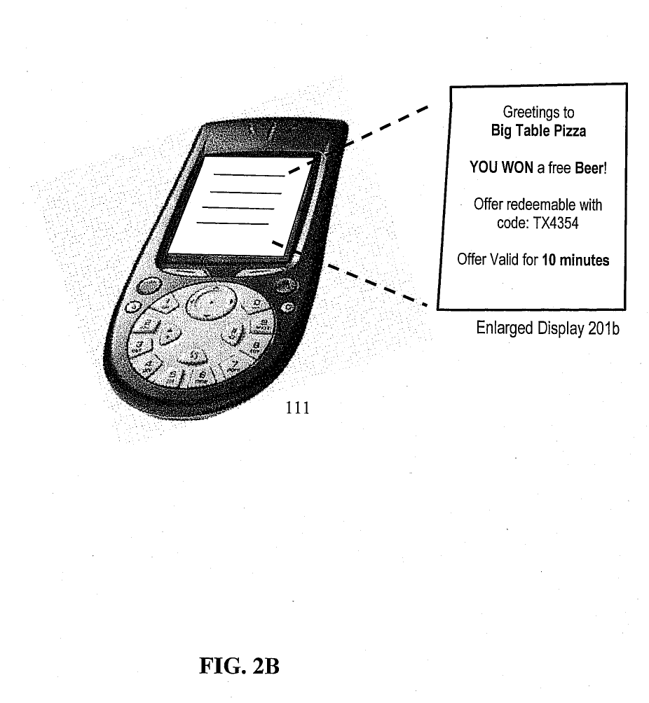

FIG. 2A illustrates a portable computing device 111 configured with appropriate hardware and software according to an embodiment of the invention. As shown FIG. 2A, the portable computing device 111 may take the form of a handheld device such as a cell phone or PDA and includes display functionality and user interface controls. Such a portable computing device 111 is operative to exchange information with the EBPTM server over a wireless communication link. The communication link may take any common form—for example a wireless communication link to an information network such as the Internet. The portable computing device 111 may also include a differential GPS transceiver for sensing the geographic location of the portable computing device with a high degree of accuracy and/or an RFID transceiver for scanning RFID chips within close proximity and/or an RFID chip for being scanned by RFID scanners within close proximity. The portable computing device 111 includes a user interface, the user interface including textual and/or graphical display features and user input features. In some embodiments a user may enter textual and/or numerical information through a keypad and send such information to the EBPTM server as an electronic message. In some embodiments a graphical user interface is enabled upon the display that allows users to enter information and/or make selections that is sent to the EBPTM server as well as allows the user to view information received from the EBPTM server. In some such embodiments graphical buttons and/or menus are employed for information selection and/or entry. In these ways, the user may use the portable computing device 111 to inform the EBPTM server as to his or her presence within a particular localized physical establishment by causing an Attendance Message relating to the establishment to be sent to the EBPTM server. In some such embodiments a user enters an Establishment ID into the portable computing device and sends it as an SMS message to the EBPTM server the SMS message comprising an Attendance Message.

In response to such Attendance Messages, the EBPTM server documents the user's attendance within the identified establishment in the Establishment Attendance Database. The EBPTM server also may be operative to automatically send establishment-specific messages back to the portable computing device of the user. In some embodiments the establishment-specific message that is sent back to the portable computing device of the user includes a Greeting Message that is specific to and/or relationally associated with the establishment identified in the Attendance Message. In some embodiments the establishment-specific message that is sent back to the portable computing device of the user includes an establishment-specific Promotional Offer that is specific to and/or relationally associated with the establishment identified in the Attendances Message. In some such embodiments, the promotion offer is sent dependent at least in part upon a Randomized Promotional Offer Process that awards the promotional offer based upon a determination of statistical chance. In some such embodiments, promotional offer is conveyed based upon a determination of statistical chance with odds of approximately one in ten. In this way a user who sends an Attendance Message from his or her portable computing device 111 to the EBPTM server 100 indicating a specific establishment (by unique Establishment ID), will automatically receive back a Greeting Message upon his or her personal computing device, the Greeting Message being relationally associated with and/or related to the identified establishment. The user will also have a one in ten chance of receiving a Promotional Offer electronic message back from the EBPTM server 100 that conveys a free or discounted product or service of the identified establishment, the result of the one in ten chance being determined by the EBPTM server. In other examples, other levels of chance may be employed, generally defined by a win_chance_value variable associated with the establishment.

The establishment-specific Greeting Message may comprise a textual and/or graphical message of welcome that is relationally associated with the establishment identified by the Attendance Message. The Greeting Message generally includes a textual and/or graphical an indication of name (or other identifier) of the establishment that was identified by the EBPTM server in response to the received Attendance Message. Some or all of the content of each Greeting Message may be accessed from a data store that includes content for a plurality of Greeting Messages, the data store being accessible to the EBPTM server. Such a data store may be referred to as a Greeting Message Database and may be part of the Establishment Information Database described previously. In general, the content of each Greeting Message in the Greeting Message Database is indexed, at least in part, with respect to the unique Establishment ID of the establishment to which it relates. This means that the EBPTM server may access the content of a Greeting Message that is related to a particular establishment by accessing the Greeting Message Database and indexing it with the unique Establishment ID of the desired establishment. In this way, upon receiving a unique Establishment ID within an Attendance Message from the portable computing device of user, the EBPTM server may access establishment-specific Greeting Message content from a plurality of stored Greeting Message content segments, the accessed content being indexed with respect to the received Establishment ID. A Greeting Message may be composed using said content and may be sent back the portable computing device of the user. This enables a user to receive, in response to sending an Attendance Message relating to a particular establishment, a Greeting Message with content that is specific to that establishment.

For example, a user may send an Attendance Message to the EBPTM server that includes the Establishment ID value #12321 which is the unique ID assigned to an establishment called Pete's Bar and Grill. In response to receiving this unique ID, the EBPTM server accesses the Greeting Message Database, using the unique ID 12321 as an index value. Content is accessed that includes the phrase, “Welcome to Pete's Bar and Grill.” This content is then added to a composed Greeting Message and sent to the portable computing device of the user who sent in the Attendance Message. The user thus receives a Greeting Message upon his or her portable computing device that includes the message content, “Welcome to Pete's Bar and Grill”. This provides a confirmation to the user that the Attendance Message was received by the EBPTM server and that the correct establishment was identified by the EBPTM server. In this way the user knows that his attendance has been logged in the correct establishment. If a welcome message was received that included a wrong establishment name, the user would know that either the wrong ID was sent or the server made an incorrect determination of attendance.

In some embodiments the return Greeting Message may also provide the patron with historical data about his or her patronage with respect to the identified establishment. For example, data may be included within the returned Greeting Message that and indicates the number or frequency of visits that the patron has had to the identified establishment over a prior period of time. This data may also include information about the time period (in hours, days, weeks, or other units) since the user's last visit to the establishment. This data may also include the time, date, day of week, or other temporal identifier of the last visit made by the particular user to the particular establishment. Such data may be accessed by the EBPTM server from the Establishment Attendance Database described previously, indexed with respect to the unique user ID of the particular user and the unique establishment ID of the particular establishment.

Referring again to FIG. 2A, an example portable computing device 111 of the current invention is shown, with the portable computing device 111 including a display screen 201a that shows an example Greeting Message as it may be displayed to a user after being received from the EBPTM server over a wireless communication link. Just previous to this instant in time, the portable computing device sent an Attendance Message to the EBPTM server including the unique Establishment ID for an establishment called Joe's Bar and Grill that the user 108 has just entered. In response to receiving the Attendance Message, the EBPTM server 100 accesses greeting message content from the Greeting Message Database, indexed with respect the Establishment ID received in the Attendance Message. The EBPTM server also accesses historical patronage data for the user 108 of the portable computing device 111, the historical patronage data being accessed with respect to his or her previous visits to the Joe's Bar and Grill establishment. This is accessed from the Establishment Attendance Database, indexed with respect to the unique user ID of the user 108 and the unique Establishment ID of the establishment. It should be noted that the unique user ID of the user 108, may be a unique electronic address of the portable computing device 111, for example the phone number of that device Using the accessed data (i.e. the greeting message content and the historical patronage data), a greeting message is then composed by the EBPTM server, the greeting message then being sent as an electronic message to the portable computing device 111 of the user 108. The greeting message is then displayed to the user on the display screen 201a of the portable computing device 111.

As shown in FIG. 2A, the displayed message on display screen 201a includes the Greeting Message content “Welcome to Joe's Bar and Grill.” At least a portion of this particular message content was accessed by the EBPTM server from the Greeting Message Database in relational association to the unique establishment ID for that establishment (i.e., the establishment identified within the previously received Attendance Message). The displayed message also includes the content “This is your 6th visit this year,” indicating that the user 108 of the portable computing device 111 has been documented in the Establishment Attendance Database as having visited the particular establishment 6 times so far this year, including the current visit indicated by the just received Attendance Message. This data was accessed by the EBPTM server form the Establishment Attendance Database and used in composing the Greeting Message. The displayed message also includes the content “We last saw you on 5/21,” indicating that the user of the portable computing device has been documented as having last visited the particular establishment on May 21st of this Calendar Year. This data was accessed by the EBPTM server form the Establishment Attendance Database and used in composing the Greeting Message. The Greeting Message may also include additional textual and/or graphical information content. In this case it includes the final phrase, “We are glad to see you again.” In this way the user 108 receives an establishment-specific Greeting Message that includes content unique to the establishment that he or she has just entered, as well as content unique to his or her personal patronage history with respect to that establishment.

In addition to the Greeting Message content specific to the establishment identified by the Attendance Message, a Promotional Award may be sent to the user dependent upon the outcome of the Randomized Promotional Offer process performed by the EBPTM server. The randomized promotional offer process may determine at random, using approximately pre-configured odds, whether or not the user is to be awarded a free or discounted product or service of the establishment identified by the Attendance Message. In an example embodiment, the approximately pre-configured odds may be one-in-ten. Thus a weighted randomization process is used to determine, with approximately one-in-ten odds, if the user is to be awarded a free or discounted product or service of the establishment. If the user is determined to win a promotional award, based at least in part upon a process of statistical chance, an establishment-specific promotional offer is sent as an electronic message to the portable computing device of the user. In some embodiments it is sent as an SMS text message. The establishment-specific promotional offers, once received by the portable computing device 111 of the user 108, are redeemable by the user 108 of the portable computing device 111 for a free or discounted product or service of the establishment. In some such embodiments the promotional offer may include a password or code key that is used by the user 108 of the portable computing device 111 to redeem the value of the promotional offer within the particular establishment to which it relates. In some embodiments the establishment specific promotional offers are time-limited, being redeemable only for a defined period of time following the transmission and/or receipt of the promotional offer electronic message.

FIG. 2B illustrates a portable computing device 111 of user 108, the portable computing device 11 displaying a greeting message and establishment-specific promotional offer, to the user, on a screen 201b according to an embodiment of the invention. The greeting message and promotional offer may be received by the portable computing device 111, from the EBPTM server 100, as a single electronic message, or as two sequential electronic messages. They may be displayed simultaneously on screen 201b, or sequentially on screen 201b. As shown, they are displayed simultaneously in this example.

As shown in screen 201b of FIG. 2B, a greeting message is displayed to the user. The greeting message includes the textual display “Greetings to Big Table Pizza.” In this example, Big Table Pizza is the name of the establishment identified by an Attendance Message just sent by user 108 using portable computing device 111 to the EBPTM server 100. In addition, the EBPTM server, using the randomized promotional offer process described above, determines that the user did win a promotional award. In this case the award is a free beer and is redeemable for a period of 10 minutes following the return of the award message. The award is redeemable with a particular authorization code: TX4353. Thus, in response to this determination, a promotional offer award message is composed by the EBPTM server and sent to the portable computing device 111. The award message is displayed on screen 201b. The message includes textual information, including the phrase “YOU WON a free Beer!” informing the user that he or she won a free beer within the identified establishment. The message also includes textual information, “Offer redeemable with code TX4354,” indicating that the promotional offer may be redeemed within the identified establishment using the provide authorization code. The message also includes the textual information, “Offer Valid for 10 minutes” indicating that the promotional offer award may be redeemed by the particular user, using the particular redemption code, within the particular establishment, for a period not to exceed 10 minutes following the transmission of the promotional offer message to the portable computing device 111 by the EBPRM server 100. In this way the user 108 of the portable computing device 111 is informed that he or she has won a free beer within the establishment he or she has just entered, in response to sending an Attendance Message regarding that establishment, and that the free beer may be redeemed by using the provided authorization code (TX4354) and that the free beer must be redeemed within 10 minutes or the offer will no longer be valid. In this way, only a user who was actually present within the establishment or other wise able to physically get to the establishment within the 10 minutes, could redeem the offer.

In many embodiments, the EBPTM server also sends a copy of the authorization code (in this example, TX4354) to an Establishment Computer 199 of the particular establishment, along with an indication of what was won (in this example, free beer) and how long it is valid (in this example, for 10 minutes from the current time). In this way an employee of the establishment who interacts with Establishment Computer 199 may be informed that an award was granted, that it may be redeemed for a period of 10 minutes, and that a particular authorization code should be presented by the customer trying to redeem the award. The user must simply show the screen 201b to an employee of the establishment to redeem the free beer in such embodiments. In some such embodiments the employee simply checks the authorization code against the codes listed on the Establishment Computer 199, and determines if the award is valid and if it was redeemed in time. The checking may be automated by software running on the Establishment Computer 199, and the employee simply types in the authorization code received from the customer to the Establishment Computer, the establishment computer reports if it is a valid code, if it was entered in time, and what the awarded product or service is.

In even more secure embodiments, the EBPTM server sends a copy of a unique user ID or other unique identifier of each winning user (for example each winning user's unique User ID code, user name, user phone number, unique user credit card number and/or unique user Driver's License Number) to an Establishment Computer 199 of the particular establishment, along with an indication of what that user won how long the promotional award is valid. In this way an employee of the establishment who interacts with Establishment Computer 199 may be informed that an award was granted, who it was granted to (by unique user identifier) and that it may be redeemed for a particular period of time. If the unique user identifier is a credit card number or driver's license number, a user may redeem his or her promotional award by simply showing a credit card and/or driver's license to an employee of the establishment that matches a credit card number and/or driver's license number that was received by the Establishment Computer 199. This provides an easy way of verifying that the correct user is redeeming a valid promotional award within a correct establishment within an allotted promotional time. To enable such embodiments, the EBPTM server maintains within the Personal Profile Database of users, a unique identifier for each user that may be verified, such as a credit card number, driver's license number, social security number, or other similar identifier. In some such embodiments the employee simply checks the identifier, provided by the user, against the received identifier on the Establishment Computer 199, and determines if the award is valid and if it was redeemed in time. In some embodiments the checking is automated by software running on the Establishment Computer 199, the employee simply typing in the identifier (i.e. the credit card number and/or driver's license number) received from the customer to the Establishment Computer, the establishment computer reporting if it is a valid code, if it was entered in time, and what the awarded product or service is.

It should be appreciated, that as used herein, “portable computing device” should be broadly construed as including any mobile wireless client device, e.g., a cell phone, pager, a personal digital assistant, a mobile computer with a smartphone client, or the like. A typical portable computing device may be a wireless access protocol (“WAP”)-enabled device that is capable of sending and receiving data in a wireless manner using the wireless application protocol. The WAP protocol allows users to access information via wireless devices, such as mobile phones, pagers, two-way radios, communicators, and the like. WAP supports wireless networks, including CDPD, CDMA, GSM, PDC, PHS, TDMA, FLEX, ReFLEX, iDEN, TETRA, DECT, DataTAC, and Mobitex, and it operates with many handheld device operating systems, such as PalmOS, EPOC, Windows CE, FLEXOS, OS/9, and JavaOS. Typically, WAP-enabled devices use graphical displays and can access the Internet (or other communication network) on so-called mini- or micro-browsers, which are web browsers with small file sizes that can accommodate the reduced memory constraints of handheld devices and the low-bandwidth constraints of a wireless networks. In a representative embodiment, the mobile device is a cellular telephone that operates over General Packet Radio Service (GPRS), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. In an illustrated embodiment, mobile device users use SMS, which is a text message service that enables short messages (e.g., generally no more than 140-160 characters in length) to be sent and transmitted from a portable computing device. The present invention is not limited to mobile device users who have WAP-enabled devices or to use of any particular type of wireless network. Such devices and networks are merely illustrative; any wireless data communication technology now known or hereafter developed may be used in connection with the invention.

Embodiments of the invention provide a useful software architecture. As described above, a database of personal profile information for a plurality of users that is generally maintained and/or accessed by the EBPTM server 100 and is referred to herein as a Personal Profile Database (PP Database). In one example embodiment the Personal Profile Database is indexed by a unique user ID for each user of the system. Indexed with respect to a user's unique user ID is a set of personal characteristics that described that particular individual including but not limited to that person's age, gender, highest level of schooling, marital status, political party affiliations, school affiliations, team affiliations, club affiliations, organizational affiliations, hobbies, interests, profession, job title and/or hierarchy level within an organization, sexual orientation, annual income, sporting team preferences, status as a tourist or resident within the current geographic region, relationship status (e.g., whether in a relationship or looking for a relationship), musical preferences, IQ, entertainment preferences, food preferences, and/or other similar personal characteristics that describe an individual. The profile data may also include height and/or weight information for the user, and/or size information for the user with respect to clothing such as shirt size, pants size, and/or shoe size. The profile data may also include eye color and/or hair color of the user. In some embodiments the personal profile data also includes clothing taste information for the user, including preference towards particular clothing brands and/or styles of dress. In some embodiments the personal profile data include color preference data for the user. The personal profile data may include unique identifier values such as a driver's license number, credit card number, social security card number, and/or ID card number of the user. In many embodiments of the present invention a user enters their personal characteristics and/or preferences through a user interface upon registering for the service. In addition, users of the present invention can update their personal characteristics as stored within the database from time to time as personal characteristics change. For example, if a user gets married he or she may update his or her personal characteristics related to marital status. In addition, the personal characteristics may include the user's birth date such that his or her age can be automatically updated by the software that maintains the Personal Profile Database and/or EBPTM application as his or her age changes over time. The personal profile database may also include an electronic address of a portable computing device of each of a plurality of users. In some embodiments an electronic address of the user is used as the unique ID of the user. In some embodiments an electronic address of the user is mapped through a relational association to the unique ID of the user, the unique ID of the user thereby being retrievable using one or more electronic addresses of portable computing devices of the user.

As also described previously, the EBPTM server 100 is also operative to access and/or maintain an Establishment Attendance Database, the database including current patronage data for each of a plurality of localized physical establishments, the data indicating each of a plurality of users who are currently believed to be in attendance within each establishment of a plurality of establishments. The database also includes historical patronage data for each of a plurality of localized physical establishments, the historical data indicating past patronage to each of a plurality of establishment by each of a plurality of users. Such data may include a record of which users visited which establishments, when the visits occurred, and how long the visits lasted. The database is indexed with respect to the unique User ID of individual users and the unique Establishment ID of individual establishments. In this way the EBPTM server may access, by unique establishment ID, a record of which patrons are currently present within an establishment and/or a record of which patrons have visited the establishment over a prior period of time. It should be appreciated that patron visits to establishments may be stored in said data stores such that it reflects the time, date, and/or day of week, that each patron visited each establishment. In addition, a record of how many times a particular patron has visited a particular establishment during a particular time period may be stored within the data store. In some embodiments of the present invention the EBPTM server maintains data about each of the users that reflect their visiting behavior with respect to particular location based establishments, for example, an indication of which location based establishments have been visited by a particular user (indexed with respect to that users unique ID) and the frequency and/or number of times the user has visited each location based establishments.

As described above, in response to receiving an Attendance Message from a particular user that indicates his or her attendance within a particular establishment, the EBPTMS is operative to (a) document that the particular user's attendance in particular establishment within the Establishment Attendance Database, (b) return a Greeting Message to the portable computing device of the particular user, the Greeting Message being establishment-specific to the particular establishment identified in the Attendance Message, (c) perform a randomized promotional offer process to determine at random, using approximately pre-configured odds, whether or not the user is to be awarded a free or discounted product or service of the establishment identified by the Attendance Message, and (d) send any resulting promotional offer award to the user as an electronic message sent to a portable computing device of the user, the promotional award being establishment-specific and optionally being time-limited.

In some embodiments the Greeting Message may include data relating to the particular user's previous attendance history with respect to the particular establishment. The data may be accessed from the Establishment Attendance Database.

In some embodiments the content of the Greeting Message may be selected from the Greeting Message Database based at least in part upon unique demographic information about the user accessed from the Personal Profile Database (indexed with the unique User ID of the user). For example, if the user is documented as being male, different greeting message content may be returned as compared to if the user is documented as being female. Similarly, the greeting message content may be selected from the Greeting Message Database based upon the age, gender, school affiliation, team affiliation, food preferences, music preferences, clothing size, political party affiliation, and/or marital status of the user. In this way the Greeting Message content may be selected from a plurality of possible greeting message content segments based upon both (a) the unique Establishment ID of the particular establishment and (b) one or more unique demographic characteristics of the particular user.

In some embodiments the particular Promotional Offer that is awarded to the user may be selected for the user from a plurality of possible promotional offers stored within Promotional Offer Database (which is part of the Promotional Message Database) based at least in part upon the particular user's previous attendance history with respect to the particular establishment. The data may be accessed from the Establishment Attendance Database.

In some embodiments the particular Promotional Offer that is awarded to the user may be selected for the user from a plurality of possible promotional offers stored within Promotional Offer Database based at least in part upon unique demographic information about the user accessed from the Personal Profile Database (indexed with the unique User ID of the user). For example, if the user is documented as being male, different promotional offer content may be awarded to the user as compared to if the user is documented as being female. Similarly, the selected promotional offer that is awarded to the user may be selected from the Promotional Offer Database based at least in part upon the age, gender, school affiliation, team affiliation, food preferences, music preferences, clothing size, political party affiliation, and/or marital status of the user (as accessed from the Personal Profile Database indexed with the user's unique ID). In this way a promotional offer may be selected from a plurality of promotional offers based upon both (a) the unique Establishment ID of the particular establishment and (b) one or more unique demographic characteristics of the particular user.

As described previously, upon receiving an Attendance Message indicating that a particular user is present within a particular establishment, the EBPTM server updates an Establishment User List for that establishment. In some such embodiments, the user is removed from the list automatically after a certain elapsed time has passed from the time the EBPTM server received the visit indication. For example, in some embodiments the EBPTM server removes a user from the Establishment User List (n) minutes after receiving the indication of attendance of that user within the establishment, where (n) is a number that may be set depending upon the type of establishment. As used herein, (n) is referred to as the “time_out_period” for the particular establishment. If the establishment is a restaurant, (n) may be set, for example, to 90 minutes. If the establishment is a retail store (n) may be set, for example, to 20 minutes. If the establishment is a movie theater, (n) may be set, for example, to 120 minutes. In this way a user may be removed from the Establishment User List some anticipated amount of time after being added to the list, unless the user sends a repeat Attendance message informing the EBPTM server as to his or her continued patronage of the localized physical establishment. In this way the present invention enables a “tell us you're here” architecture for tracking the patronage of localized physical establishments by users of portable computing devices such that a patron is assumed to have departed the establishment some pre-configured amount of time after the last “tell us you're here” message is received by the EBPTM server for that patron's visit to that particular establishment.

With respect to the Time_Out_Period variable described above, each unique establishment may have a unique Time_Out_Period associated with it. Thus the variable may be an array indexed by unique Establishment ID. This may be of the form:
Time_Out_Period (Establishment_ID)

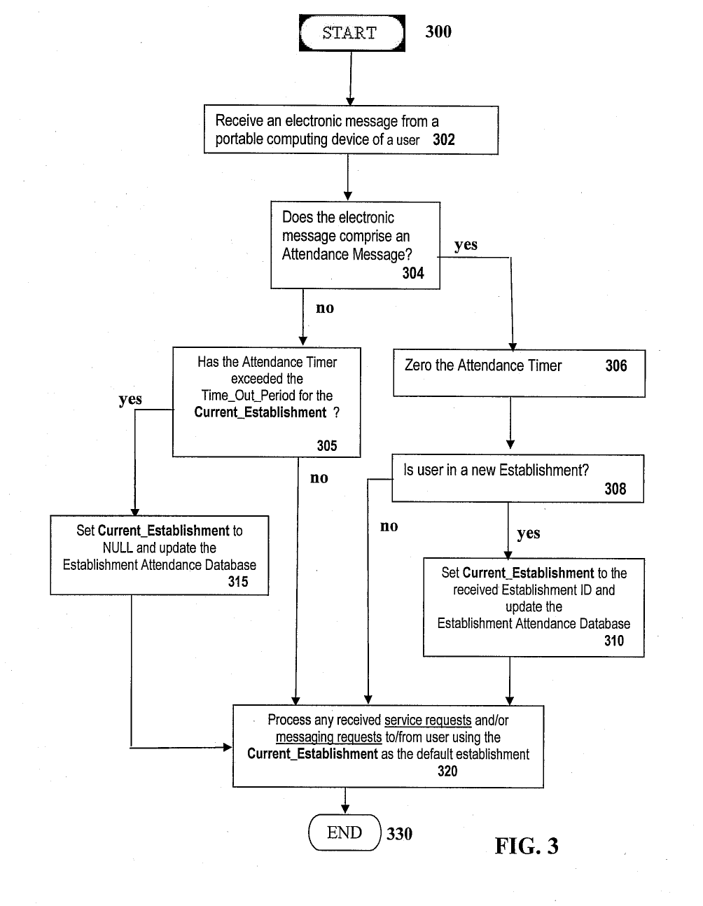

FIG. 3 illustrates a flowchart of an example process that supports the maintenance of the Establishment Attendance Database based upon received Attendance Messages and tracking of attendance time_outs for particular establishments according to an embodiment of the invention. As shown, the process starts at 300 where the routine is called. At step 302 an electronic message is received by the EBPTM server 100, the electronic message being sent from a portable computing device 111 of a user 108. In general the user 108 is one of a plurality of users being serviced by the EBPTM server 100. The electronic message may be sent in a variety of forms. In one example embodiment the electronic message is an SMS text message sent from the portable computing device 111 of the user. The electronic message is parsed by the EBPTM server 100 to determine its contents and the type of message it comprises.

At step 304 a determination is made as to whether the electronic message comprises an Attendance Message. If it is an Attendance Message it will include an indication that the particular user has arrived within and/or is present within a particular establishment. The particular establishment will be identified by a unique Establishment ID. The particular user will be identified by a unique User ID which may be a unique value associated with the user and/or a unique address of the portable computing device of the user. If the message is an Attendance Message, it comprises a current indication that the identified user is in attendance within the identified establishment. If so, the process branches to step 306 where an Attendance Timer is set to zero. This time is an incremental timer that will count elapsed time from the moment it is zeroed, forward. The Attendance Timer variable is generally indexed with respect to the unique ID of the user because every user will have a separate Attendance Timer related to the establishment that he or she is currently patronizing. This is because each of a plurality of users have an Attendance_Timer variable associated with the current establishment they are in. Thus the Attendance_Timer variable may be an array indexed as follows:
Attendance_Timer (User ID)

At step 306, Attendance_Timer(User_ID) using the ID of the current user is set to 0. Prior to this, Attendance_Timer(User_ID) may be a time value that indicates the elapsed time since the last time the value was zeroed.

The process then proceeds to step 308 where a determination is made as to whether the establishment indicated by the received Attendance Message is a new establishment (i.e., has the user entered a new establishment) or is it the same establishment as one the user was previously in. This determination is made by comparing the Establishment ID received in the Attendance Message with a value stored in a Current_Establishment variable that indicates the current establishment that the user is patronizing. The Current_Establishment variable is generally indexed with respect to the unique ID of the user, because each of a plurality of users have a Current_Establishment variable associated with them. Thus the Current_Establishment variable may be an array indexed as follows:
Current_Establishment (User_ID)

It should be noted that if the user is not currently documented as being within an establishment at the current time, this variable is set to a NULL value.

Thus, at step 308, a determination is made as to whether the user has entered a new establishment. If so, the process branches to step 310 where the Current_Establishment variable for that user is updated. This is achieved by setting Current_Establishment for the current user to the Establishment ID that was received in the Attendance Message at step 304. In addition the Establishment Attendance Database is updated at step 310, documenting the presence of the particular user within the particular establishment, optionally including time and date and day values for the visit. This documents the current establishment being patronized by the user. The process then proceeds to step 320. If the determination made at 310 was such that the user was NOT in a new establishment (i.e. the Attendance Message indicated the same Establishment ID as the current establishment currently documented for the user), the process jumps directly to step 320, without performing step 310.

At step 320, the EBPTM server is operative to process any service requests and/or information requests received from the particular user using the Current_Establishment as the default establishment for the service request. For example, if the user sends a subsequent request asking for a digital menu to be downloaded, the EBPTM server accesses and downloads the menu associated with the Current_Establishment. In this way, the user may make a variety of service requests to the EBPTM server, without again identifying a unique ID of a particular establishment, and the EBPTM server will use the Current_Establishment value stored for that user at the current time. This is a convenience for the user, freeing him or her from repeatedly informing the server as to which establishment he or she is making service and/or information requests with respect to. At step 320, the EBPTM server is also operative to process any pending messaging requests relating to the particular user using the Current_Establishment as the default establishment for the messaging request. For example, if there are any pending establishment-specific promotional messages relating to the Current_Establishment and to the current user, those messages will be forwarded to the current user at this time. Similarly, any pending person-to-person establishment-specific messages and/or establishment-specific reminder messages, relating to the Current_Establishment and the particular user, they will be forwarded to the particular user at this time. As described previously, the establishment-specific promotional messages may include promotional offers, the promotional offers optionally being time-limited promotional offers.

Referring back to step 304, if the message received from the user was not an Attendance Message, the process branches to step 305. At step 305, the Attendance Timer is checked for the Current_Establishment is to see if the Time_Out_Period for that establishment has been exceeded by the current value of the Attendance Timer for the current user. Said another way, a conditional statement is executed checking:
if Attendance_Timer (User_ID)>Time_Out_Period (Establishment_ID)

If so, that means the user associated with the current User ID has been within the current establishment for a period of time that exceeds the Time_Out_Period for that establishment without a fresh Attendance Message being received. If this is the case, the process branches to step 315 and the Current_Establishment is set to NULL. In other words, enough time has passed since the last Attendance Message was received form the current user to assume that the user is no longer within the establishment identified by the last Attendance Message. Thus the Current_Establishment is set to NULL. Also, the Establishment Attendance Database is updated to reflect the user as no longer being present within the previous Current Establishment. The process then proceeds to step 320.

If the conditional statement in step 305 above determined that the user associated with the current User ID has NOT been within the current establishment for a period of time that exceeds the Time_Out_Period for that establishment without a fresh Attendance Message being received, the process jumps directly to step 320 without any changes being made. It should be noted that the Attendance_Timer variable is continually incremented over time using a background process. Finally, the process proceeds to step 330 where the routine ends. In a typical embodiment it is immediately called again, starting again at step 300. It should also be noted that in some embodiments a user may send an Exit Message to the EBPTM server, the Exit Message specifically indicating that the user has exited the current establishment. Such an Exit Message, upon receipt, causes the process of FIG. 3 to jump directly to step 315, which sets the Current Establishment to NULL and updates the Establishment Attendance Database accordingly.

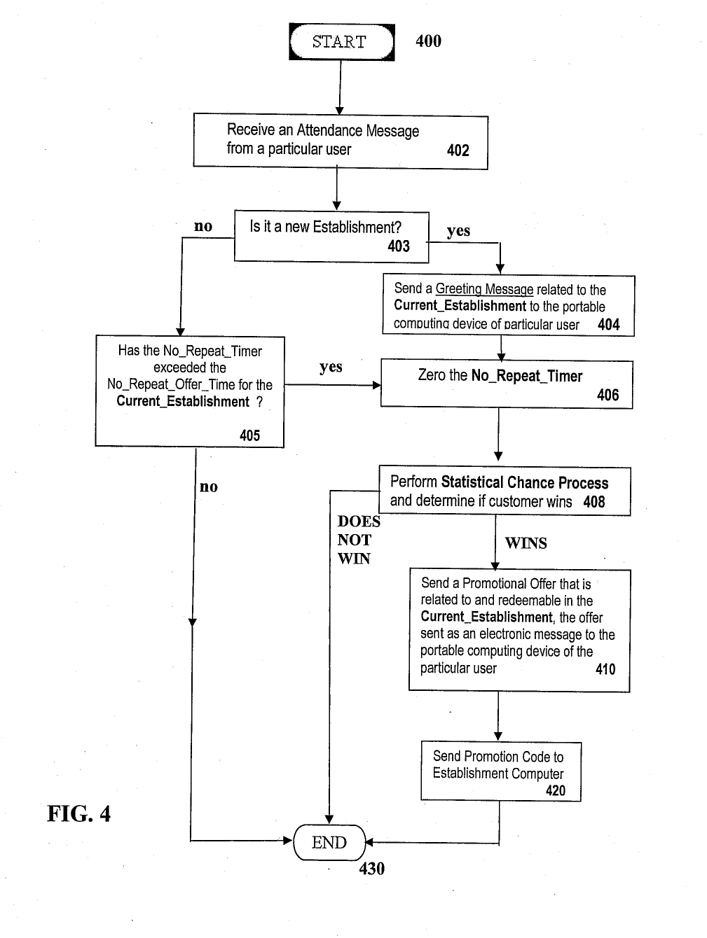

The above process describes an example embodiment of how a record of patron attendance is maintained by the EBPTM server over a period of time following the receipt of an Attendance Message. FIG. 4 illustrates a process for returning Greeting Messages and/or Promotional Offers to the portable computing devices of patrons in response to the receipt of an Attendance Message according to an embodiment of the invention. The promotional offers are dependent at least in part upon a randomized promotional offer process in which a user is awarded a free or discounted product or service of a localized physical establishment based at least in part upon a process of statistical chance. It should be appreciated that the processes of FIGS. 4 and 3 are related processes that may be run in parallel or may otherwise be combined.

As shown in FIG. 4, a process starts at step 400 and proceeds to step 402 when an Attendance Message is received form a particular user. The process then proceeds to step 403 where a conditional determination is made as to whether or not the establishment indicated by the received Attendance Message is a new establishment (i.e., has the user entered a new establishment) or is it the same establishment as one the user was previously in. As described above, this determination is made by comparing the Establishment ID received in the Attendance Message with a value stored in a Current_Establishment variable that indicates the current establishment that the user is patronizing.

If the determination indicates that the user is in a new establishment (i.e., the Establishment ID received in the Attendance Message is different than the previously determined Current_Establishment for that user), the process branches to step 404. If the determination indicates that the user is not in a new establishment (i.e., the Establishment ID received in the Attendance Message is the same as the previously determined Current_Establishment for that user), the process branches to step 405.

It should be appreciated that if it is determined that the user has entered a new establishment at step 403, the Current_Establishment value is updated to reflect the Establishment ID of the new establishment. This step is not shown in FIG. 4, but is instead shown in FIG. 3 at step 310.

At step 404, a Greeting Message is composed (as described above) and sent (as also described above) by the EBPTM server 100 to the portable computing device 111 of the user. The Greeting Message may employ establishment-specific content that is selected, at least in part, based upon the Establishment ID received in the Attendance Message. In other words, the establishment-specific content is selected, based at least in part, upon the Current_Establishment value. The process then proceeds to step 406.

At step 406, a no_repeat_timer variable is zeroed. This is a variable that will count incremental time (generally as a background timer process), following the receipt of an Attendance Message. The no_repeat_timer variable is generally unique to the particular user from whom the Attendance Message was received. The process then proceeds to step 408.

At step 408 the EBPTM server performs a Statistical Chance Process to determine whether the user (i.e., the user who sent the Attendance Message) is selected to win a free or discounted product or service of the particular establishment (i.e., the establishment identified by the Attendance Message). The statistical chance process generally includes a random selection process that has substantially pre-defined statistical odds. The statistical odds may be set for the particular establishment in an establishment-specific variable, for example the win_chance_value(Establishment ID) described above. This value may be set, for example, to one-in-ten. Thus a random selection process is performed to determine, with one-in-ten odds, if the user is awarded a free or discounted product or service of the establishment. If the user wins, the process branches to step 410. If the user does not win, the process branches to step 430 and ends.

At step 410 a promotional offer is conveyed as an electronic message to the portable computing device of the user, the promotional offer being selected from the Promotional Offer Database such that it is establishment-specific to the current_establishment and optionally selected based upon the patronage history and/or demographics of the particular user. The promotional offer is conveyed as an electronic message, as described previously, such that it is redeemable within the current_establishment, optionally within a particular defined time duration. The promotional offer may include a promotion code or other unique authorization value that is sent by the EBPTM server to the portable computing device. The process then proceeds to step 420.

At step 420 a copy of the promotion code, or other unique promotional offer authorization value, is sent by the EBPTM server to an Establishment Computer 199 of the particular establishment. This authorization confirmation step was described in detail previously in this document. The process then proceeds to step 430 and ends.

Referring back to the alternate branch at step 403, if the establishment indicated by the Attendance Message was not a new establishment, the process branches to step 405. At step 405 the no_repeat_timer variable is checked to see if it exceeds a no_repeat_offer_time for the particular establishment (i.e., for the establishment indicated by the current_establishment value). The no_repeat_offer_time variable refers to a time duration (for a particular establishment) for which a user may not be again considered for a promotional offer, even if the user sends multiple Attendance Messages during that time duration. In other words, the user only gets one chance to win a promotional offer from a particular establishment when the user sends an Attendance Message, unless a time period has passed that is greater than the no_repeat_offer_time for that establishment. This is checked at step 405.

Thus at step 405 a determination is made as to whether enough time has passed since it was determined that the user was first in attendance within the current establishment (i.e., has the no_repeat_timer exceeded the no_repeat_offer_time for the current_establishment). If so, the process branches to step 406, where the no_repeat_timer is zeroed. The process then continues on as before to step 408 and beyond, where the user has a statistical chance of winning a free or discounted product or service of the current establishment.

If at step 405 the determination indicates that enough time has not passed since it was determined that the user was first in attendance within the current establishment (i.e., the no_repeat_timer hasn't exceeded the no_repeat_offer_time for the current_establishment) then the process proceeds to step 430, and ends.

The process of FIG. 4 is generally repeated each time a new Attendance Message is received. In addition, background processes generally occur between the receipt of Attendance Messages, such as the incremental timing accrual of the no_repeat_timer.

Finally, it should be appreciated that in some embodiments a record of the promotional offers won by users at step 410 are stored in a memory accessible to the EBPTM server. This may include a Historical Winnings Database that is indexed with respect to each unique establishment (by unique Establishment ID), by each unique user (by unique User ID), and by each unique promotional offer (by unique Promotional Offer ID). In this way a historical record may be kept of which users have been awarded which promotional offers within which establishments. In some embodiments this Historical Winnings Database may also include a record of whether or not an awarded promotional offer was redeemed by the awarded user within the particular establishment to which it relates. To store such data, a confirmation message must be received by the EBPTM server indicating if a particular promotional award is redeemed. In some embodiments this is conveyed as an electronic message from the Establishment Computer 199 to the EBPTM server, indicating when a particular promotional offer has been redeemed by a particular user within a particular establishment. In some embodiments such a redemption indication is indexed with respect to the unique promotion code (or other unique identifier) assigned to the particular promotional award within the particular localized physical establishment.

In some embodiments the Historical Winnings Database may be used to prevent a particular user from being awarded the same promotional award within the same localized physical establishment more than a certain number of times within a particular time period. In some embodiments, the certain number of times is once. In some such embodiments, the particular time period is stored as a variable referred to as the no_repeat_win_time, as described previously, the no_repeat_win_time being associated with a particular promotional offer and/or with a particular localized physical establishment. Thus in some embodiments the EBPTM server may be configured such that a particular user may not win a particular promotional offer that is redeemable within a particular localized physical establishment more than once within a particular time period that is defined by the no_repeat_win_time variable.

In some embodiments, a no-win-message is sent to the portable computing device of the user in response to a determination at step 408 that the user did not win a promotional award of the particular establishment. The no-win-message may be an electronic message, for example a text message, including an informative phrase indicating that the statistical chance process was performed and that the results indicated that the user did not win. In this way a user knows that he or she had a chance, was considered, and did not win. The phrase may be, for example—“Sorry, you did not win this time.” In addition, the no-win-message may include an indication of how long the user must wait to try again. For example, if the no_repeat_offer_time for the particular establishment is 30 minutes, the message may say—“You may try again in 30 minutes.” In this way a user knows he can send another Attendance Message in 30 minutes or more, and try again to win.

An embodiment of the invention is directed to a method of providing an automated chance-based promotional award service for physical establishments. A unique establishment identifier is associated with each of a plurality of physical establishments. An electronic attendance message is received from each of a plurality of portable computing devices, each electronic attendance message conveying an establishment identifier and a user identifier, and each electronic attendance message indicating that a user associated with the user identifier is currently in attendance within a physical establishment associated with the establishment identifier. A determination is made, for each of a plurality of received attendance messages, whether the user associated with the received user identifier wins a free or discounted product or service of the physical establishment associated with the received establishment identifier. The determination is based at least in part upon a process of chance. An electronic award message is sent to the portable computing device of at least one user who is determined to win a free or discounted product or service of at least one establishment, the electronic award message indicating that the at least one user has won the free or discounted product or service of the at least one establishment.

The electronic award message sent to the portable computing device of the at least one user may be redeemable by the at least one user within the at least one establishment for the free or discounted product or service. The electronic award message may include at least one of a password or code that is redeemable within the at least one establishment for the free or discounted product or service. A copy of the at least one of a password or code is also sent to an establishment computer associated with the at least one establishment. The process of chance may be configured with preset odds. The preset odds may be configured such that for at least one received electronic attendance message, the user has a statistical chance of approximately one in ten of winning the free or discounted product or service.

Each electronic attendance message received from each of the plurality of portable computing devices may be an SMS text message. The electronic award message may be an SMS text message sent to the portable computing device. The free or discounted product or service may be at least one of a free or discounted drink, desert, and appetizer. The process of chance may be configured such that statistical odds that a particular user wins a free or discounted product or service of a particular establishment is based at least in part upon a historical record of patronage of that particular user with respect to that particular establishment.

The electronic award message may be time-limited such that the free or discounted product or service may only be redeemed within the at least one establishment during a limited time period. At least one of the portable computing devices may be a mobile phone. The user identifier may be at least one of a phone number associated with the portable computing device from which the attendance message was received and a name of the user of the portable computing device from which the attendance message was received.

The foregoing described embodiments of the invention are provided as illustrations and descriptions. They are not intended to limit the invention to the precise forms described. In particular, it is contemplated that functional implementation of the invention described herein may be implemented equivalently in hardware, software, firmware, and/or other available functional components or building blocks. No specific limitation is intended to a particular system or device. Other variations and embodiments are possible in light of above teachings, and it is not intended that this Detailed Description limit the scope of invention

This invention has been described in detail with reference to preferred and alternate embodiments. It should be appreciated that the specific embodiments described above are merely illustrative of the principles underlying the inventive concept. It is therefore contemplated that various modifications of the disclosed embodiments will, without departing from the spirit and scope of the invention, be apparent to persons of ordinary skill in the art.

Other embodiments, combinations and modifications of this invention will occur readily to those of ordinary skill in the art in view of these teachings. Therefore, this invention is not to be limited to the specific embodiments described or the specific figures provided. This invention has been described in detail with reference to various embodiments. Not all features are required of all embodiments. It should also be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art. Numerous modifications and variations could be made thereto by those skilled in the art without departing from the scope of the invention set forth in the claims.

What is claimed is:

1. A method of providing an automated chance-based promotional award service for physical establishments, the method comprising:
associating a unique establishment identifier with each of a plurality of physical establishments;
receiving an electronic attendance message from each of a plurality of portable computing devices, the electronic attendance message conveying an establishment identifier and a user identifier, and the electronic attendance message indicating that a user associated with the user identifier is currently in attendance within a physical establishment associated with the establishment identifier;
determining, for each of a plurality of received attendance messages, whether the user associated with the user identifier wins a free or discounted product or service of the physical establishment associated with the establishment identifier, the determining being based at least in part upon a process of chance; and
sending an electronic award message to a portable computing device of at least one user who is determined to win a free or discounted product or service of at least one establishment, the electronic award message indicating that the at least one user has won the free or discounted product or service of the at least one establishment.

2. The method of claim 1 wherein the electronic award message sent to the portable computing device of the at least one user is redeemable by the at least one user within the at least one establishment for the free or discounted product or service.

3. The method of claim 1 wherein the electronic award message includes at least one of a password or code that is redeemable within the at least one establishment for the free or discounted product or service.

4. The method of claim 3 wherein a copy of the at least one of a password or code is also sent to an establishment computer associated with the at least one establishment.

5. The method of claim 1 wherein the process of chance is configured with preset odds.

6. The method of claim 5 wherein the preset odds are configured such that for at least one received electronic attendance message, the user has a statistical chance of approximately one in ten of winning the free or discounted product or service.

7. The method of claim 1 wherein the electronic attendance message received from each of the plurality of portable computing devices is an SMS text message.

8. The method of claim 1 wherein the electronic award message is an SMS text message sent to the portable computing device.

9. The method of claim 1 wherein the free or discounted product or service is at least one of a free or discounted drink, desert, and appetizer.

10. The method of claim 1 wherein the process of chance is configured such that statistical odds that a particular user wins a free or discounted product or service of a particular establishment is based at least in part upon a historical record of patronage of that particular user with respect to the particular establishment.

11. The method of claim 1 wherein the electronic award message is time-limited such that the free or discounted product or service may only be redeemed within the at least one establishment during a limited time period.

12. The method of claim 1 wherein at least one of the plurality of portable computing devices is a mobile phone.

13. The method of claim 1 wherein the user identifier is at least one of a phone number associated with the portable computing device from which an attendance message was received and a name of the user of the portable computing device from which the attendance message was received.

14. A system for providing a chance-based promotional award service for physical establishments, the system comprising:
a centralized server in processing communication with a plurality of portable computing devices, the centralized server executing routines for:
receiving an electronic attendance message from each of the plurality of portable computing devices, each received electronic attendance message indicating that a user associated with a portable computing device is currently in attendance within an identified physical establishment;
determining, for each of a plurality of received attendance messages, whether the user associated with the portable computing device wins a free or discounted product or service of the identified physical establishment, the determining being based at least in part upon a process of chance; and
sending an electronic award message to the portable computing device of at least one user that is determined to win a free or discounted product or service of an identified establishment, the electronic award message indicating that at least one user has won the free or discounted product or service of the identified establishment.

15. The system of claim 14 wherein the electronic award message sent to the portable computing device of the at least one user is redeemable by the at least one user within the identified establishment for the free or discounted product or service.

16. The system of claim 14 wherein the electronic award message includes at least one of a password or code that is redeemable within the identified establishment for the free or discounted product or service.

17. The system of claim 16 wherein a copy of the at least one of a password or code is also sent to an establishment computer associated with the identified establishment.

18. The system of claim 17 wherein the at least one of a password or code is displayed to an employee of the identified establishment for redemption verification purposes.

19. The system of claim 14 wherein the process of chance is configured with preset odds.

20. The system of claim 19 wherein the preset odds is approximately a statistical chance of one in ten.

21. The system of claim 14 wherein the electronic attendance message received from each of the plurality of portable computing devices is an SMS text message.

22. The system of claim 14 wherein the electronic award message is an SMS text message sent to the portable computing device.

23. The system of claim 14 wherein the free or discounted product or service is at least one of a free or discounted drink, desert, and appetizer of the identified physical establishment.

24. The system of claim 14 wherein the electronic award message is time-limited such that the free or discounted product or service may only be redeemed by the at least one user within the identified establishment during a limited time period.

25. A method of providing a chance-based promotional award service for physical establishments, the method comprising:
receiving an electronic attendance message from a mobile telephone device, the electronic attendance message indicating that a user associated with the mobile telephone device in attendance at a particular physical establishment;
determining, in response to receiving the electronic attendance message, whether the user associated with the mobile telephone device wins a free or discounted product or service of the particular physical establishment, the determining being based at least in part upon a process of chance; and
sending an electronic award message to the mobile telephone device indicating that the free or discounted product or service of the particular physical establishment has been won, the sending being performed based at least in part upon the determining being affirmative.

26. The method of claim 24 wherein the electronic award message sent to the mobile telephone device is redeemable within the particular physical establishment for the free or discounted product or service.

27. The method of claim 25 wherein the receiving, determining, and sending are performed by a remote computer server that is in processing communication with the mobile telephone device over a wireless communication network.

28. The method of claim 25 wherein the receiving, determining, and sending are performed for each of a plurality of separate mobile telephone devices, a user of each of the plurality of separate mobile telephone devices being given a separate chance of winning a free or discounted product or service of the particular physical establishment.
